(19) United States
(12) Patent Application Publication
(10) Pub. No.: US 2026/0277203 A1
(43) Pub. Date: Sep. 17, 2026

(54) MASON RESET BASED CONTROL

(71) Applicant: CLEVELAND STATE UNIVERSITY, Cleveland, OH (US)

(72) Inventors: Zhiqiang Gao, Cleveland, OH (US); Yu Hu, Cleveland, OH (US)

(21) Appl. No.: 19/430,835

(22) Filed: Dec. 23, 2025

Related U.S. Application Data
(60) Provisional application No. 63/771,695, filed on Mar. 14, 2025.

(51) Int. Cl. G05B 19/418

(52) U.S. Cl. CPC G05B 19/41885; G05B 2219/32411; G05B 2219/34042

(57) ABSTRACT

An industrial controller is designed to implement a closed-loop control approach referred to as Mason reset based control, or MRBC. MRBC control is founded on the design principles of reset and synchronization. In general, MRBC controllers replace the explicit integrator in proportional-integral-derivative (PID) control with a generalized reset loop, which can ensure the controller itself is stable, thus mitigating or eliminating the problem of integral windup ubiquitous in current PID controllers.

### CROSS-REFERENCE TO RELATED APPLICATIONS

This application claims priority to U.S. Provisional Patent Application Ser. No. 63/771,695, filed on Mar. 14, 2025, and entitled “MASON RESET BASED CONTROL,” the entirety of which is incorporated herein by reference.

### TECHNICAL FIELD

This disclosure generally relates to control systems, and, more specifically, to closed-loop control of systems and processes

### BACKGROUND

Many industrial automation applications employ closed-loop control systems to control mechanical motion systems or industrial processes. Motion control systems typically include a motor or other type of actuator operating under the guidance of a controller, which sends position or speed control instructions to the motor in accordance with a user-defined control algorithm. Some motion control systems operate in a closed-loop configuration, whereby the controller instructs the motor to move its corresponding load to a target position or to transition to a target velocity (a desired state) and receives feedback information indicating an actual state of the motor or its load. The controller monitors the feedback information to determine whether the motor has reached the target position or velocity, and adjusts the control signal to correct errors between the actual state and the desired state.

Similar control techniques are also used in process control applications. In the case of process control applications, the control signal generated by the controller regulates one or more process variables in accordance with a control algorithm, and a measured value of the process variable is provided to the controller as feedback data, allowing the controller to adjust the control signal as needed based on the actual value of the process variable relative to a desired setpoint.

Many industrial controllers perform closed-loop control using proportional-integral-derivative (PID) control. This control approach requires the designer of the control system to determine and set suitable values of the controller parameters; namely, the controller's proportional, integral, and derivative gains. The process of selecting suitable gain coefficients for the controller is known as tuning. Designers typically seek to select values of these controller parameters to achieve an optimal trade-off between performance and system stability. For example, an aggressively tuned controller may result in a system that tracks a desired position or setpoint with high accuracy and a fast response time, but may be rendered unstable in the presence of system noise and uncertainties. Alternatively, tuning the controller more conservatively will improve system stability, but at the expense of performance.

There is no formal methodology, commonly agreed upon by the scholar and engineers in the field of control engineering, for determining optimal values of the PID controller parameters, and consequently the PID users usually resort to a time-consuming trial-and-error process to obtain a set of PID gain constants that yield a control response with much room for improvements. It is reported that some 80% of PID loops in process control industry are badly tuned. Moreover, a given PID controller tuning is generally specific to its control application or plant, and is not scalable or portable to other control applications, even if those applications are designed to perform broadly similar control functions.

Also, the integral term in PID control, which is designed to obtain zero steady state error as it influences the control signal based on an accumulation of past error over time, can introduce control instability when the feedback signal is interrupted or when the actuator is saturated and therefore unable to respond to requests from the control signal from the controller. In such situations, the integral term continues to accumulate the error while the actuator is unable to respond to the control signal requested by the controller, leading to instability and the runaway of the control signal. This phenomenon is known as integral windup.

The above-described is merely intended to provide an overview of some of the challenges facing conventional industrial control systems. Other challenges with conventional systems and contrasting benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its purpose is to present some concepts of one or more embodiments in a simplified form as a prelude to the more detailed description that is presented later.

One or more embodiments of the present disclosure relate to industrial control systems that implement a control structure based on the Mason Reset (MR), which was invented by Clemson E. Mason in 1930 to achieve zero steady state error under load change. Conventionally, the terms “reset control” and “integral control” have been used interchangeably in control literature, and indeed their equivalency when the control loop remains intact and the controller operates in the linear region is well established. However, reset control and integral control differ in terms of windup when the controlled actuator is saturated. While the reset windup is a problem of saturation, the integrator windup is one of stability. As discussed herein, there is no advantage gained in replacing MR with an integrator in a control loop, or in integrating the error directly as in PID control, since doing so causes controller instability and renders the ad hoc patch stabilization, known as anti-windup, unavoidable. Accordingly, one or more embodiments described herein provide industrial controllers that implement MR-based control (MRBC) as an alternative to integral control as used in PID control systems. As discussed herein, replacing the explicit integrator in PID with a generalized reset loop can achieve stable performance that mitigates or eliminates the problem of integral windup without integrating accumulated past error over time as is done by integral control.

Moreover, a direct extension to MR moves its pole to the left-half-plain and gives a scalable degree of integration as a tradeoff between steady state accuracy and the controller stability. Essentially, MR-based control (MRBC) is scalable in gain and in time to accommodate various process characteristics and design specifications, and can be readily deployed in scale industry wide.

The MRBC controllers described herein successfully address the problem of PID tuning by offering a transparent and science-based tuning approach, in contrast to overly complex and esoteric methods from academia and the trial-and-error nature of existing tuning techniques used by practitioners. This may yield at least a 10% improvement in accuracy and energy savings, in addition to significant improvements in critical areas of disturbance rejection, robustness to internal and external process changes, stability margin, noise reduction, and ease of use. The rationale is made transparent to users, eliminating guess work from the design and tuning process and making MRBC control easy to tune

The following description and the annexed drawings set forth herein detail certain illustrative aspects of the one or more embodiments. These aspects are indicative, however, of but a few of the various ways in which the principles of various embodiments can be employed, and the described embodiments are intended to include all such aspects and their equivalents.

### BRIEF DESCRIPTION OF THE DRAWINGS

FIG. 1 is a simplified diagram of a closed-loop control architecture.

FIG. 2 is a block diagram of an example industrial controller that supports MRBC control.

FIG. 3 is a diagram illustrating the concept of proportional control with a Mason Reset loop.

FIG. 4 is a diagram representing the transfer function form of MRBC.

FIG. 5a illustrates the closed-loop step and disturbance responses for various values of Tₚ using MRBC control.

FIG. 5b illustrates the loop gain frequency response for various values of Tₚ using MRBC control.

FIG. 6 is a diagram representing a common feedback control configuration.

FIG. 7 illustrates plots of the system output and control output for MRBC, standard PI, and PI with anti-windup.

FIG. 8 is a diagram representing a digital implementation of gain-scaled MR (GSMR).

FIG. 9a illustrates the closed-loop step response for gain-scaling Mason Reset with Kᵣₛ<1.

FIG. 9b illustrates the loop-gain frequency response for gain-scaling Mason Reset with Kᵣₛ<1.

FIG. 10 illustrates plots of simulation results of MRBC with gain scaling as compared with PI with anti-windup.

FIG. 11 illustrates closed-loop time response with MRBC.

FIG. 12 is a Bode diagram that plots the magnitudes and phases of the designed loop-gain frequency responses for MRBC with T_{L}=0.2T_{P} and T_{L}=T_{P}.

FIG. 13a is a Bode diagram that plots the magnitudes and phases of the individual controller, loop gain, and plant frequency response with T_{L}=0.2Tₚ,

FIG. 13b is a Bode diagram that plots the magnitudes and phases of the individual controller, loop gain, and plant frequency response with T_{L}=Tₚ.

FIG. 14 is a Bode diagram that plots the magnitudes and phases of the designed loop-gain frequency responses for MRBC with T_{L}=Tₚ, T_{L}=0.5Tₚ, and T_{L}=2Tₚ.

FIG. 15 illustrates graphs of the closed-loop time response with MRBC for MRBC with T_{L}=Tₚ, T_{L}=0.5Tₚ, and T_{L}=2Tₚ.

FIG. 16 is a diagram of a two-mass system with spring and damper.

FIG. 17 is a Bode diagram that plots the frequency responses of the plant Gₚ(s) and MRBC controlled loop-gain transfer function L_{MRBC}(s).

FIG. 18 illustrates tracking and disturbance rejection performance with actuator saturation of ±5 for Kᵣₛ=0.995 and Kᵣₛ=1.

FIG. 19 illustrates tracking and disturbance rejection performance with actuator saturation of ±1.25 for Kᵣₛ=0.995 and Kᵣₛ=1.

FIG. 20 is a flowchart of an example methodology for controlling a plant using Mason reset based control (MRBC).

FIG. 21 is a block diagram representing an exemplary networked or distributed computing environment for implementing one or more embodiments described herein.

FIG. 22 is a block diagram representing an exemplary computing system or operating environment for implementing one or more embodiments described herein.

### DETAILED DESCRIPTION

Various embodiments are now described with reference to the drawings, wherein like reference numerals refer to like elements throughout. In the following description, for the purposes of explanation, numerous specific details are set forth in order to provide an understanding of this disclosure. It is to be understood, however, that such embodiments may be practiced without these specific details, or with other methods, components, materials, etc. In other instances, structures and devices are shown in block diagram form to facilitate describing one or more embodiments.

Systems and methods described herein relate to control systems and methods that implement a generalization of PID control referred to as generic PID (or GPID), which makes explicit the basic principles and methods of how past, present, and future error are quantitatively combined in a controller design and tuning.

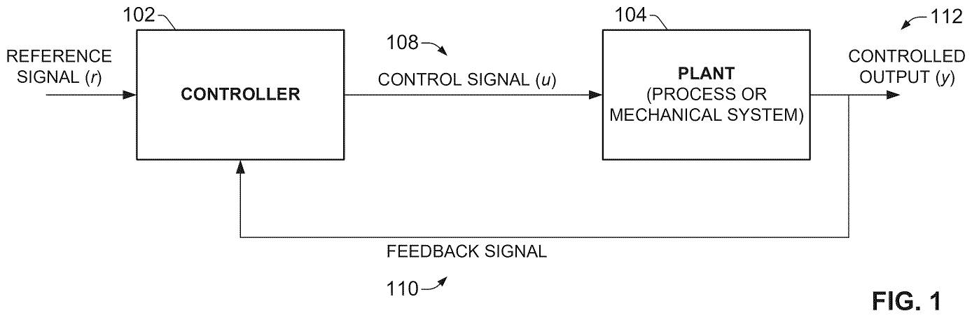

FIG. 1 is a simplified diagram of a closed-loop control architecture. Controller 102 is programmed to control plant 104, which can be a mechanical system including an actuator (e.g., a motor that drives a mechanical load, a valve that regulates a flow, etc.) or an industrial process in which one or more process variables are regulated by the controller 102 in accordance with a control algorithm. In an example mechanical application, plant 104 may be a motor-driven industrial automation application or industrial tool, including but not limited to a machining or material handling robot, a conveyor, a tooling machine, a motorized hand tool, etc. Plant 104 may also comprise a motor-driven traction or propulsion system of an electric vehicle design, including but not limited to an electric or hybrid electric automobile, a bicycle, a forklift or other industrial vehicle, a scooter, a railway vehicle such as a train, or other such vehicles. Plant 104 may also be a series of fans or pumps that are part of an HVAC (heating, ventilating, and air conditioning) system, where the speed of the motors or pumps is controlled by controller 102. Plant 104 may also be a motor-driven home or industrial appliance. For example, controller 102 may be used to control a motor that drives the drum of a home or industrial washing machine, to control the spinning of a centrifuge, or to control the motion of other such appliances. Plant 104 may also be motor-driven industrial automation system, a motion control system, an industrial tool, or an industrial robot. These example control systems are not intended to be exhaustive; rather, plant 104 can comprise substantially any type of mechanical motion system or industrial process.

Controller 102 and plant 104 make up the primary components of an example closed-loop control system. In an example mechanical application, plant 104 can represent a motor-driven axis of a single- or multi-axis robot or positioning system. In such applications, controller 102 sends a control signal (or actuating signal) 108 instructing the motor to move the mechanical load to a desired position at a desired speed, or along a desired trajectory (where the desired position or speed is set by the controller's program or based on a reference signal provided to the controller 102). The control signal 108 can be provided directly to the motor, or to a motor drive (not shown) that controls the power delivered to the motor (and consequently the speed and direction of the motor). Feedback signal 110 indicates a current state (e.g., position, velocity, etc.) of the motor and/or mechanical load in substantially real-time. In servo-driven systems, feedback signal 110 can be generated, for example, by an encoder or resolver (not shown) that tracks an absolute or relative position of the motor. In sensorless systems lacking a velocity sensor, the feedback signal can be provided by a speed/position estimator. In this example, the controlled output 112 of the plant 104—which the feedback signal 110 measures—represents the position of the load (in speed control applications, the controlled output 112 will be the velocity). During a move operation, the controller monitors feedback signal 110 to ensure that the load has accurately reached the target position or speed. The controller 102 compares the actual position or speed of the load as indicated by the feedback signal 110 with the target position or speed, and adjusts the control signal 108 as needed to reduce or eliminate error between the actual and target positions or speeds.

In another example application, plant 104 can represent a spinning load (e.g., a pump, a washing machine, a centrifuge, etc.) driven by a motor, in which controller 102 controls the rotational velocity of the load. In this example, controller 102 provides an instruction to the motor (via control signal 108) to transition from a first velocity to a second velocity, and makes necessary adjustments to the control signal 108 based on feedback signal 110 (in this example, the controlled output 112 of plant 104 is the velocity).

It is to be appreciated that the MR-based control techniques of the present disclosure are not limited to use with the example types of control systems described above, but rather are applicable to substantially any type of motion control or industrial process application.

As noted above, many controllers 102 control their plants 104 using a PID control loop. PID control, as a mathematical equation and an algorithm, has been a dominant control technology for many years, and has remained essentially unchanged. The design principle behind PID control has never been made explicitly intelligible. Instead, there is only a vague understanding that the control signal is based on past, present and future information on tracking error. It has not been systematically established how this information is defined, obtained, and brought together in a proper combination. Together with parameter tuning, PID design is still very much an art, requiring a trial-and-error approach by experienced control engineers. As a result, a majority of industrial control loops are not tuned properly, resulting in unnecessary energy waste and performance degradation. Moreover, PID control as a dominant technology is not easily scalable to higher order, more complex dynamic processes, severely limiting its effectiveness as a general-purpose solution of industrial control.

Also, as discussed above, the integral term in PID control renders the controller itself unstable and the control system susceptible to integral windup when the actuator is saturated or the feedback signal is interrupted in transmission.

To address these and other issues, one or more embodiments described herein provide an industrial controller designed to implement a closed-loop control approach described herein as Mason reset based control, or MRBC. MRBC control is founded on the design principles of reset and synchronization. In general, MRBC controllers replace the explicit integrator in PID control with a generalized reset loop, which can achieve stable performance that mitigates or eliminates integral windup. The original Mason Reset is formulated mathematically herein for use in general purpose digital controller design.

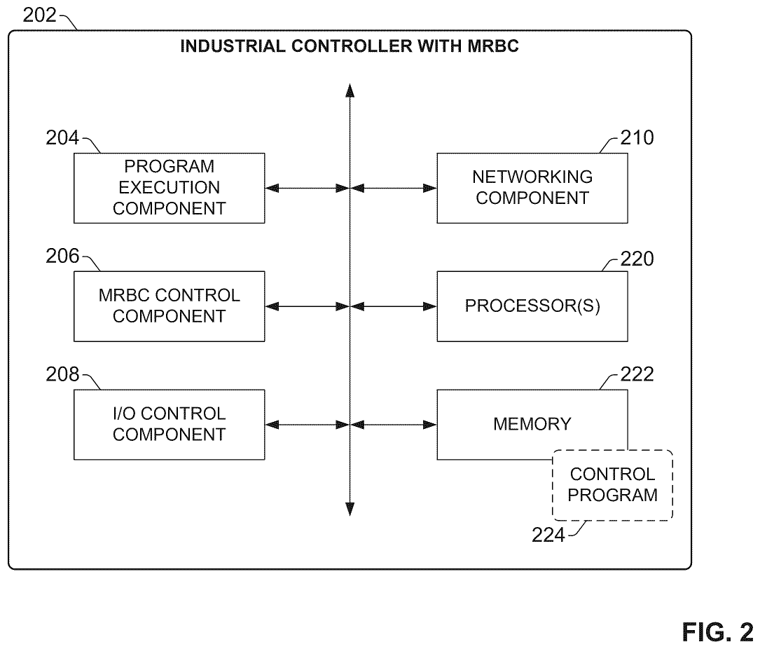

FIG. 2 is a block diagram of an example industrial controller 202 that supports MRBC control. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines—e.g., computers, computing devices, automation devices, virtual machines, etc.—can cause the machines to perform the operations described. Industrial controller 202 can be substantially any type of industrial control device, including but not limited to a programmable logic controller (PLC), a safety relay or safety controller, a motor drive, a system-on-chip (SoC), a soft controller, or another type of control device or system.

Industrial controller 202 can include a program execution component 204, a MRBC control component 206, an I/O control component 208, a networking component 210, one or more processors 220, and memory 222. In various embodiments, one or more of the program execution component 204, MRBC control component 206, I/O control component 208, networking component 210, the one or more processors 220, and memory 222 can be electrically and/or communicatively coupled to one another to perform one or more of the functions of the industrial controller 202. In some embodiments, components 204, 206, 208, and 210 can comprise software instructions stored on memory 222 and executed by processor(s) 220. Industrial controller 202 may also interact with other hardware and/or software components not depicted in FIG. 2. For example, processor(s) 220 may interact with one or more external user interface devices, such as a keyboard, a mouse, a display monitor, a touchscreen, or other such interface devices.

Program execution component 204 can be configured to compile and execute a user-defined control program 224 or executable interpreted code stored on the controller's memory 222. In various embodiments, the control program 224 can be written in any suitable programming format (e.g., ladder logic, sequential function charts, structured text, C++, Python, Javascript, etc.) and downloaded to the industrial controller 202. Typically, the control program 224 uses data values read by the industrial controller's analog and digital inputs as input variables, or received via network component 210, and sets values of the industrial device's analog and digital outputs (or sets values of networked outputs) in accordance with the control program instructions based in part on the input values.

MRBC control component 206 can be configured to control a value of a control signal u based on measured error e using MRBC control principles to be described in more detail herein. I/O control component 208 can be configured to control the electrical output signals of the industrial controller's digital and analog electrical outputs in accordance with the control program outputs, and to convert electrical signals on the industrial device's analog and digital inputs to data values that can be processed by the program execution component 204. Analog outputs that act as control signals to a plant or process can be controlled based on part on a target process parameter value set by the control program 224 and computations performed by the MRBC control component 206 to keep the actual value of the process parameter in line with the desired value set by the program 224. Networking component 210 can be configured to exchange data with one or more external devices over a wired or wireless network using any suitable network protocol.

The one or more processors 220 can perform one or more of the functions described herein with reference to the systems and/or methods disclosed. Memory 222 can be a computer-readable storage medium storing computer-executable instructions and/or information for performing the functions described herein with reference to the systems and/or methods disclosed.

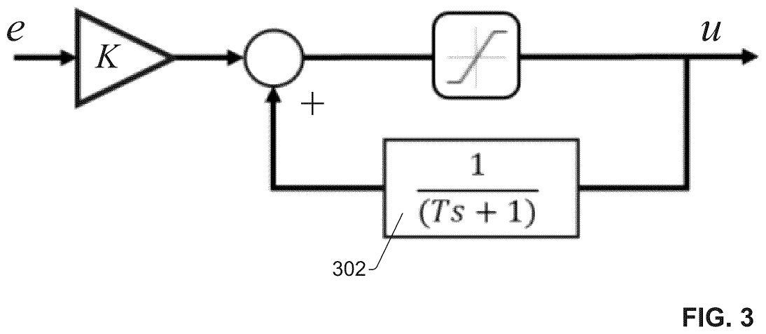

The term “reset” is used in industry to refer to the adjustment of the bias b, set initially during startup, in the control signal for the purpose of removing the offset in the controlled variable often caused by the load change. Proportional control can be expressed as

$$u = Ke + b \qquad ( 1 )$$

where u is the controller output, e is the controller's input (that is, the error or deviation of the controlled variable from its desired or reference value, often set by the control program 224), K is the proportional gain, and b is the bias that had been set manually until the invention of automatic reset by Clesson E. Mason in 1930. FIG. 3 is a diagram illustrating the concept of proportional control with a Mason Reset loop. Mason replaces the bias b in equation (1) with a positive feedback loop from the controller output u, tempered with a lowpass filter 302. This concept has become central to the series PID, also denoted as the interacting form of PID, commonly used in industrial controllers.

The series PID represented by FIG. 3 has been put into common practical use, while noninteracting (parallel) PID is sometimes deemed more general and more difficult to tune manually than series PID. It is possible that crucial insights from earlier inventions have been lost, contributing to the continuing difficulties in PID tuning.

Conceptually, with the Mason Reset (MR) loop shown in FIG. 3, control action u is generated by applying the error correction term Ke to the previous control action at t≈T, where T is the time constant of the lowpass filter in the positive feedback loop. It is this positive feedback loop inside the controller that makes possible “definite control,” a term coined by Mason to mean that the controlled variable will definitely return to the setpoint after a load change. Implemented in hardware, the control signal u is always subjected to its saturation limits.

Mathematically, when u is not saturated, the controller in FIG. 3 is equivalent to a proportional-integral (PI) control in the form

$$u = K ( e + \frac{1}{{T}_{i}} \int e ) \qquad ( 2 )$$

where Tᵢ=T is called the integrator time constant in control literature, which typically considers “reset” and “integral” to be interchangeable terms.

However, the difference between “reset” and “integral” is of fundamental importance. To understand this difference, it is important to first distinguish between integrator windup in equation (2) and reset windup in FIG. 3. With MR, u goes into saturation in reset windup but remains bounded physically. But when the MR loop is replaced digitally by the integrator in equation (2), u can easily run away in the event of a sustained deviation of the controlled variable because the controller itself is unstable. Therefore, the main difference between reset and integral control is that one is BIBO (bounded-in, bounded-out) stable and the other is not. This suggests that replacing the integrator with MR can yield more stable control. Accordingly, embodiments described herein expand Mason's invention into digital control in the form of MR-based control design.

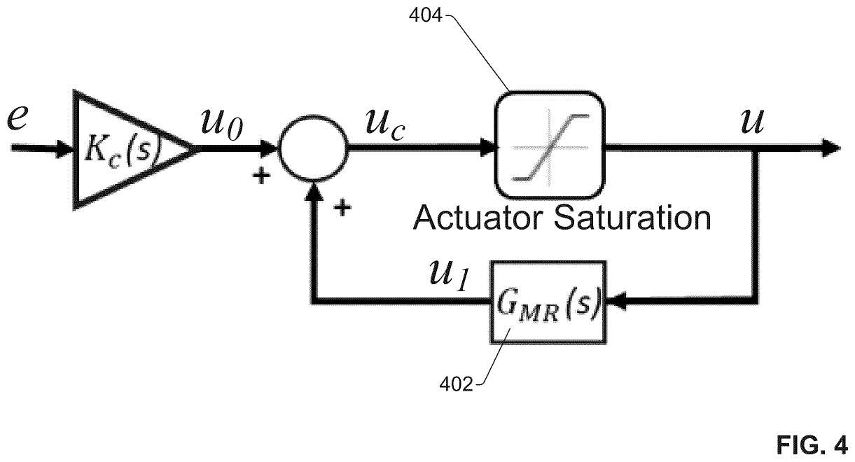

Mason's invention was originally conceived within the context of a pneumatic temperature regulation mechanism. Ignoring actuator dynamics and its internal compensation, MR can be represented in its transfer function form illustrated in FIG. 4, where the control signal u consists of two signals: the error correction in the form of u₀ and the reset in the form of u₁ as a positive feedback. In addition, u is subject to the saturation limits inherent in the mechanical design. The actuators all have upper and lower limits and this should be reflected in the control law to avoid a control signal runaway situation, as will be explained below. The Mason Reset is now represented as a positive feedback with the lowpass filter 402 given by

$${G}_{MR} ( s ) = \frac{1}{{T}_{rs} s + 1} \qquad ( 3 )$$

where Tᵣₛ is a time constant and s is the LaPlace variable. Ignoring the actuator model block, the transfer function between u₁ and u is

$${G}_{M R E} ( s ) = ( 1 + \frac{1}{{T}_{r s} s} ) \qquad ( 4 )$$

With K_{c}(s)=K, the overall controller transfer function from e to u is reduced to the form of a standard PI

$${G}_{M R B C} ( s ) = K ( 1 + \frac{1}{{T}_{r s} s} ) \qquad ( 5 )$$

which led to the prevailing notion in literature that the Mason invention of 1930 is another form of PI. However, it has been noted that there is a major difference with controller saturation: the integral control will run away (windup) when, for example, the actuator reaches its saturation limit and the error is no longer responding to the changes in u. The original reset control depicted in FIG. 4, however does not have such a problem because of the saturation limits in FIG. 4. That is, the equivalency between MRBC and PI shown in equation (5) is only valid if the control system operates in the linear region.

When G_{MR}(s) is implemented digitally, it is not limited to the simple form of equation (3). Some of the basic concepts and principles behind the Mason invention are now described.

It has been commonly interpreted that a PID controller adjusts a control signal based on the past, present, and future control errors. MRBC offers an alternative explanation: the positive feedback loop, which is uncommon in the literature of automatic control dominated by negative feedback, provides the memory of the past control action, u(t−Tᵣₛ), approximately, which is causally related to the current output y(t) (the measured value of the plant's controlled variable) and its deviation from the setpoint e(t). The time constant Tᵣₛ therefore corresponds essentially to the time constant of a first order plant. The error correction term, i.e., u₀(t), in FIG. 4, is then applied on this past control action. In other words, central to an effective control means is its capacity to remember the previous control action that aligned in time to the current error upon which the correction is made. This operating principle is denoted herein as the Principle of Reset (PoR).

That is, the error correction, under the umbrella of feedback and is the focus of control theory, is just one part of the control action: reset, or the retention of the memory of the past control action, is the other part that has been eluded in the collective awareness of the field of control. Both are essential, however. In other words, the essence of the integral control action is the memory retaining mechanism, in the form of MR. What is being retained in the memory is not of the past error, as commonly described in the literature, but of the past control action that aligned in time with the current process output. The correction is applied on this past control action to form the new control action, in perpetuity. We denote this temporal alignment between the error and the past control action to which it corresponds the Principle of Synchronization (PoS).

Consider, for example, the common first-order-plus-time-delay (FOPTD) process model

$${G}_{p} ( s ) = \frac{{K}_{p}}{{T}_{p} s + 1} {e}^{- {T}_{L} s} \qquad ( 6 )$$

where Kₚ, Tₚ, and T_{L} are the DC gain, process time constant, and the pure delay time, respectively. The common practice in industry, with a negligible delay or T_{L}≈0, is to set the integral time constant Tᵢ=Tᵣₛ equal to Tₚ, which can now be explained. In this case, Tₚ defines the temporal relationship between the input and output of the plant, to which the error correction on the control action needs to be synchronized in time: the current output is caused by the control action roughly Tₚ seconds ago (pure delay approximated by the first order lag), which is the basis for correction. Taking this one step further to the general case of FOPTD where T_{L} is no longer negligible, Tᵣₛ is selected as

$${T}_{rs} = {T}_{p} + {T}_{L} \qquad ( 7 )$$

As an alternative to (7) in the presence of a very large time delay, the delay in the feedback loop in FIG. 4 can be included, as given by

$${G}_{M R} ( s ) = \frac{{e}^{- {sT}_{L}^{′}}}{{T}_{r s} s + 1} \qquad ( 8 )$$

with Tᵣₛ=Tₚ and

$${T}_{L}^{′} = {kT}_{L} ,$$

where k is a positive constant between 0 and 1. This delay term

$${e}^{- {sT}_{L}^{′}}$$

is infinite dimensional and non-minimum phase, which could introduce complications in the loop dynamics. Note that equations (7) and (8) only provide guidelines and there is much design freedom to be explored, particularly with the complications associated with long time delays.

As an example, the robustness of MRBC is tested with an example controller designed for Kₚ=1, Tₚ=10, and T_{L}=0 to make the closed-loop time constant T_{cl}=10, but the actual Tₚ varies between 50% and 200% of its nominal value.

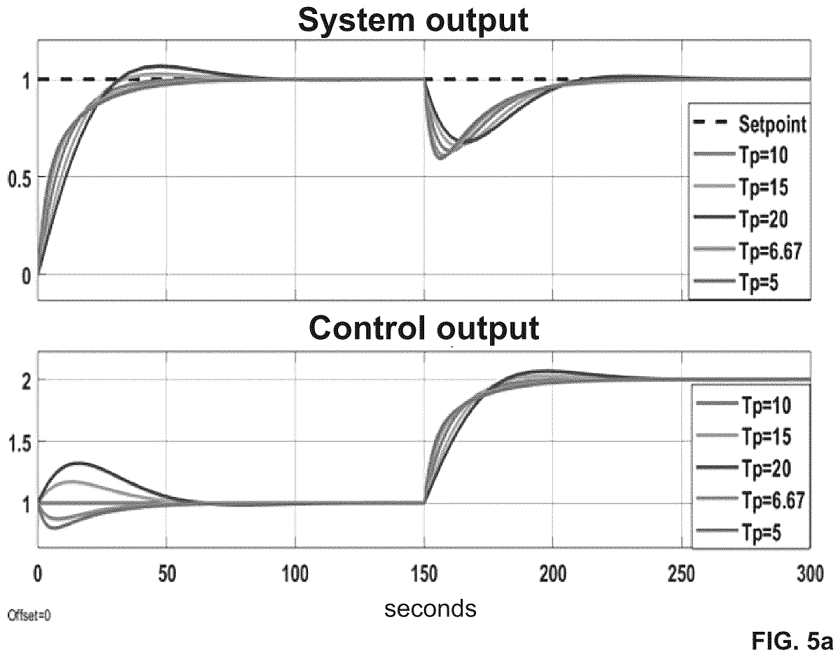

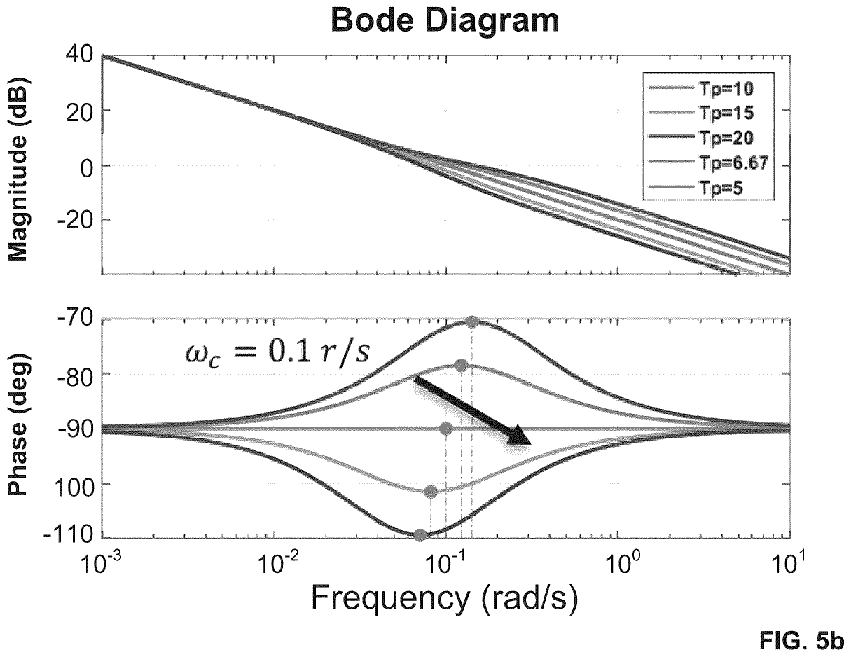

With Tᵣₛ=Tₚ=10, G_{MR}(s) in (3) and K_{c}(s)=1 in FIG. 4, the closed-loop time constant is indeed T_{cl}=10. To show the quality of tracking, disturbance rejection, and robustness against changes in Tₚ, a unit step setpoint is set at t=0, an input disturbance of −1 occurs at t=150 seconds, and Tₚ varies between 50% and 200% of its nominal value. FIG. 5a illustrates the closed-loop step and disturbance responses for various values of Tₚ, and FIG. 5b illustrates the corresponding loop gain frequency response, which indicates that the MRBC is both a simple and effective solution.

As can be seen in FIGS. 5a and 5b, the MRBC is robust against variations in the plant dynamics. In addition, it can be observed that when Tᵣₛ is greater than Tₚ, the disturbance response is slightly larger but the phase margin increases. The situation reverses when Tᵣₛ is below Tₚ. This provides a guide for trade-off between performance and stability margin.

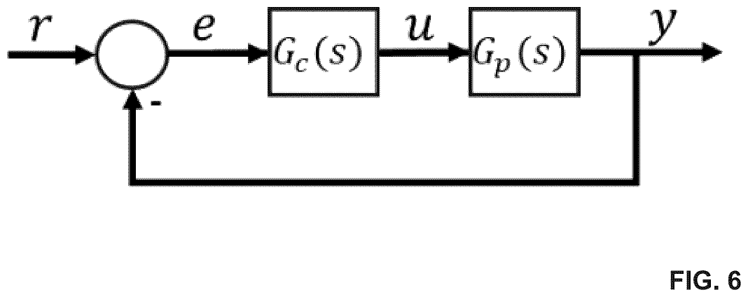

Taking the concept one step further, the MRBC control structure illustrated in FIG. 4 shows that the control action is not solely produced by a transfer function with the error as its input, as is conventionally described in control literature and represented generally by the control configuration illustrated in FIG. 6. Instead, the control structure consists of two actions represented by

$${u}_{0} = {K}_{c} ( s ) \qquad ( 9 )$$

$$and$$

$${u}_{1} = {G}_{M R} ( s ) u \qquad ( 10 )$$

Equation (9) is identical to what G_{c}(s) generates in FIGS. 5a and 5b, but equation (10) has yet to be fully acknowledged, explained, and explored nearly a century after its invention. The POR and PoS above are an attempt to offer such acknowledgement and explanation, and its variations will be further explored below.

The missing Mason Reset loop inside the controller is a possible cause of a contradiction inherent in automatic control systems: if a controller designed to keep e zero only responds when e is not zero, what does the controller do when e becomes zero but u cannot be zero? The predominant explanation is that an integrator inside G_{c}(s) remembers the past and is able to produce a nonzero output when its input is zero. But how can a controller solely described by its transfer function, which by definition is only capable of producing zero-state response, prescribe a zero-input response exactly to keep e=0, and what is the principle behind this? The lack of understanding of the machinery called PID is perhaps the main reason PID tuning and control is currently practiced as an art rather than a science.

MRBC offers a simple and logical explanation in breaking up the control action into two parts:

$${u}_{0} = {K}_{c} ( s ) e \qquad ( 11 )$$

$$and$$

$${u}_{1} = {G}_{M R} ( s ) u \qquad ( 12 )$$

as shown in FIG. 4. MRBC also provides a clear rationale for the design and tuning of control systems.

The difference between the two control narratives represented by FIG. 4 and FIG. 6 is particularly noteworthy in terms of integrator windup. The PI and MRBC equivalency in equation (6) only holds when u is not saturated. When u does saturate, the PI will have a windup problem but the MRBC of FIG. 4 does not, as demonstrated in the following example.

In this example, it is shown that there is no integrator windup in MRBC. This example assumes the same plant and controller as in the example above (which gave rise to the responses shown in FIGS. 5a and 5b), except with the setpoint set to 10 at t=0, changing to 5 at t=100 seconds. With the actuator saturation limits set at [0, 9.9], this will cause actuator saturation and integrator windup in the pure PI implementation of equation (5). The purpose is to show that MRBC as implemented in its original form shown in FIG. 4 does not have such a windup problem. Furthermore, to make the simulation more realistic, the load is changed from zero to −5 at t=200 seconds and 5 at t=300 seconds, respectively, together with some white noise added to the output measurement with a peak-to-peak value of about 1% of its setpoint.

For comparison, the standard PI implementation of equation (5) with the anti-windup mechanism is also included, from which the proportional and integral gains are set to P=2.7 and I=0.3 for both Pls and the MRBC, where

$${K}_{C} ( s ) = P = 2.7 , {T}_{rs} = \frac{P}{I} = 9 .$$

A back-calculation method is used for the anti-windup with the tracking gain

$${K}_{b} = {T}_{t}^{- 1}$$

and Tₜ=1 second, where the saturation limits in the actuator model are set at [0, 10] to reflect that the actuator limits are not always exactly known. This kind of one-sided saturation is commonly seen in practices where, in a typical thermal process as an example, the actuator is a heater with limited capacity and cooling is done only through nature dissipation.

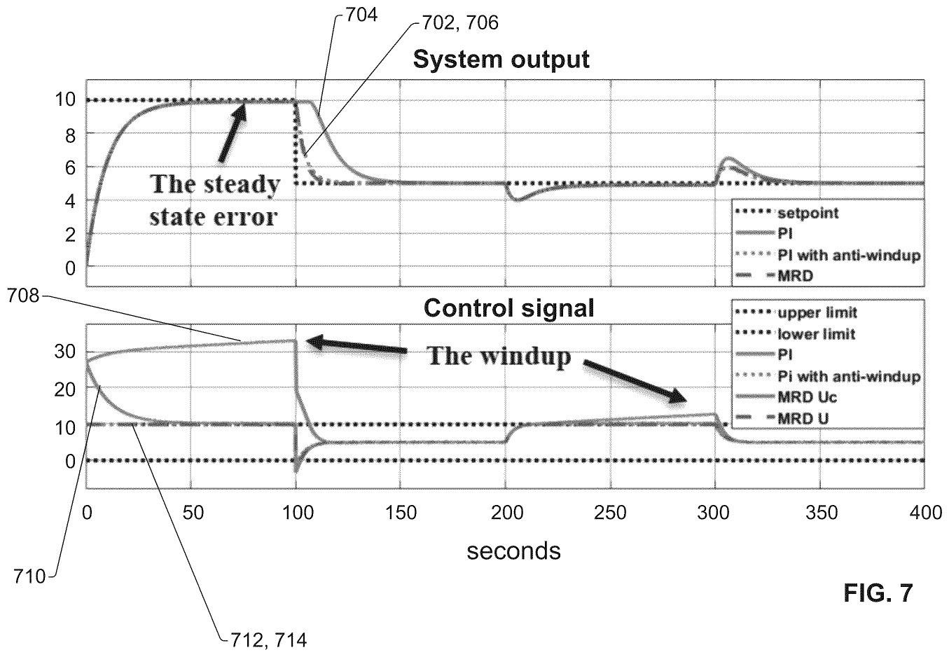

The simulation results are shown in FIG. 7, which compares MRBC, standard PI, and PI with anti-windup. Lines 702, 704, and 706 are the system output for MRBC, standard PI, and PI with anti-windup, respectively. Line 708 is the control signal for PI, lines 710 and 712 are control signal uc and u, respectively, for MRBC, and line 714 is the control signal for PI with anti-windup. As expected, MRBC and PI with anti-windup show no steady state error, unlike the pure PI controller. Note that, for MRBC, the uc signal before the saturation block 404 in FIG. 4 does go over the saturation limit initially but quickly converges to u. The pure PI, as expected, does show the integral windup problem in FIG. 7. Therefore, it can be concluded that the simple structure of MRBC represented by FIG. 4 avoids the integral windup problem altogether while keeping the steady state error to zero. The assumption of knowing the actuator saturation limit a priori will be further relaxed in examples presented below.

The simulation results show that, unlike the PI equivalent in equation (5), MRBC implemented as shown in FIG. 4 does not have a windup problem, even when the saturation limit is not exactly known. Therefore, there is no need for an anti-windup patch in MRBC.

It is generally desirable that the controller itself is stable so that control signal runaway (windup) does not occur when the feedback path is broken due to unforeseen events such as a faulty sensor or disconnected wires, or when the actuator saturates. The anti-windup mechanism in commercial PID software is, in essence, a patch for keeping its output from running away in such situation. The controller signal in MRBC, on the other hand, is saved by the inherent saturation block 404 shown in FIG. 4—which enforces limits on the upper and lower values of u_{c}—and is therefore windup-proof. It is in this sense that the MRBC is internally stable. In other words, the tracking error should not be integrated directly as in conventional PID. Instead, the integrator control should always be implemented as in the original MR shown in FIG. 4, even in digital form.

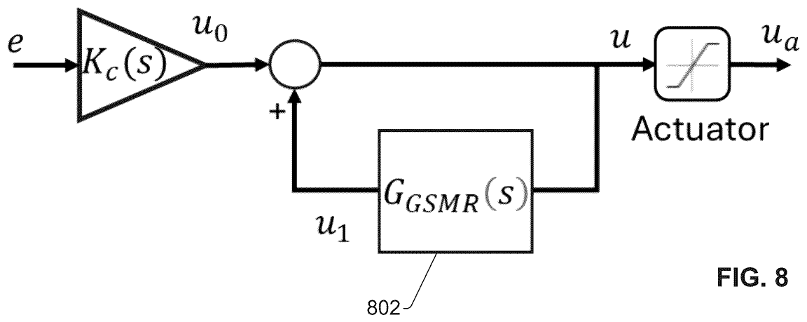

The Mason Reset of equation (3) can be further improved by gain-scaling in the form shown in FIG. 8, which is a representation of a digital implementation of the gain-scaled MR (GSMR). In this case, with the G_{MR}(s) in equation (3) replaced by

$${G}_{GSMR} ( s ) = \frac{{K}_{r s}}{{T}_{r s} s + 1} \qquad ( 13 )$$

where Kᵣₛ, 0<Kᵣₛ≤1 is the gain scaling factor and the transfer function between u₀ and u is

$${G}_{GSMRE} ( s ) = \frac{s {T}_{r s} + 1}{s {T}_{r s} + 1 - {K}_{r s}} \qquad ( 14 )$$

Note that the pure PI form of equation (4) is a special case of equation (14) when Kᵣₛ=1 and the pole at the origin makes the controller unstable and vulnerable to integrator windup. On the other hand, the approximated PI controller of equation (14) is stable with 0<Kᵣₛ≤1 even without the saturation block, since the pole of the MR loop is moved from the origin to

$$- \frac{1 - {K}_{r s}}{{T}_{r s}}$$

More importantly, Kᵣₛ, as the gain scale of MR, represents the closeness of (14) to PI and is therefore denoted as the degree of integration (Dol), or scale of integration (Sol). Here uₐ is the real actuator signal, which is physically bounded with unknown saturation limits. The corresponding MRBC transfer function between e and u is

$${G}_{MRBC} ( s ) = {K}_{c} ( s ) \frac{s {T}_{r s} + 1}{s {T}_{r s} + 1 - {K}_{r s}} \qquad ( 15 )$$

and it is stable if K_{c}(s) is stable. Furthermore, the new MRBC design shown in FIG. 8 (with a positive feedback with the lowpass filter 802 given by equation (13)) no longer requires information on the actuator saturation limits.

According to another example, consider the FOPTD in equation (6) with the same parameters as those of the previous example that was used to generate the plots of FIGS. 5a and 5b, where Kₚ=1, Tₚ=10, and T_{L}=0. It is shown that the Dol is achieved by varying Kᵣₛ between 0 and 1 with implications to both the steady state error and the low frequency loop gain.

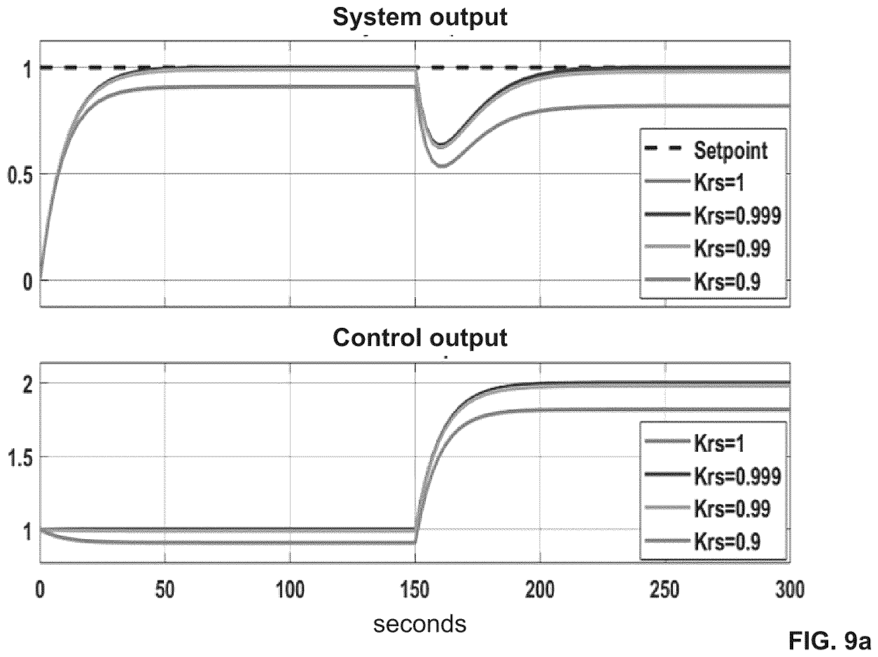

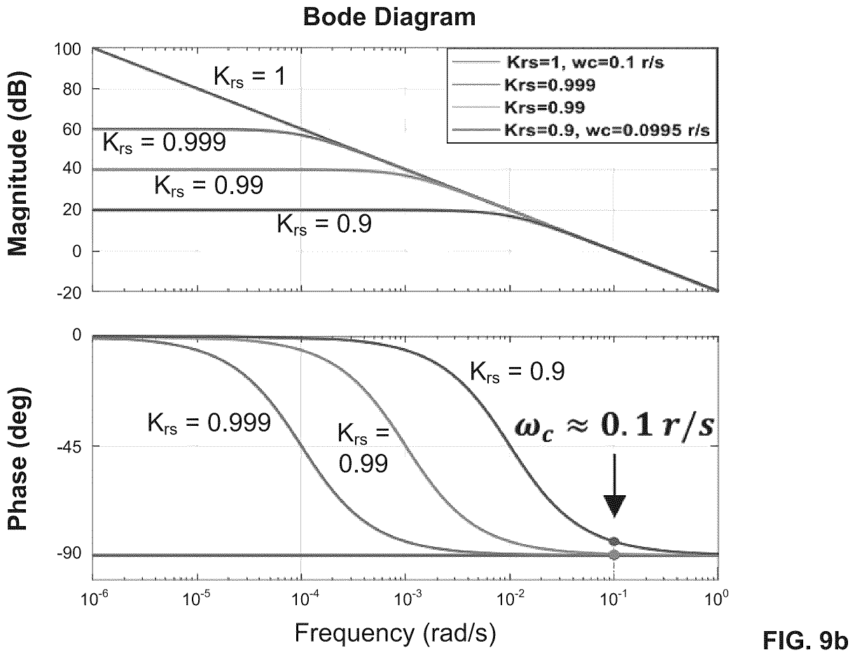

In particular, with Tᵣₛ=Tₚ=10, and K_{C}(s)=1, the effect of changing Kᵣₛ is shown in FIGS. 9a and 9b. FIG. 9a illustrates the closed-loop step response and FIG. 9b illustrates the loop-gain frequency response for gain-scaling Mason Reset with Kᵣₛ<1. In the time domain, changing Kᵣₛ mainly affects the steady state error by a few percentage points. In the frequency domain, however, there is a significant difference: both the DC gain and the corner frequency are uniquely determined by Kᵣₛ as the controller no longer has a pole at the origin for any 0<Kᵣₛ<1 and is therefore asymptotically stable. No anti-windup mechanism is needed for this controller, in contrast to PI control. The trade-off, as shown in Table I below, is that the stead state error is no longer zero and the direct current (DC) gain is no longer infinite. How close they are to the ideal PI is determined by how close Kᵣₛ is to the unity. It is in this context that Kᵣₛ is to be understood as the degree of integration (or scale of integration). It provides a new tool to engineers to balance the needs for stability and accuracy in integral control.

TABLE I

| Kᵣₛ, Degree of | DC Gain, | Steady State |
|---|---|---|
| integration, % | dB | Error, % |
| 90 | 20 | ≈10 |
| 99 | 40 | ≈1 |
| 99.9 | 60 | ≈0.1 |
| 100 | infinite | 0 |

No practical control system is required to make the tracking error perfectly zero, particularly given that all instruments have tolerances and measurements are imperfect. To require absolute zero error, steady state or not, is not realistic and inevitably leads to a PID type of controller that is not stable in itself. This is the root cause of integral windup, a term to describe instability when the controller is operating in the non-linear region typically induced by actuator saturation or broken feedback. With gain-scaled MRBC, the dilemma can be avoided, as demonstrated by the following case study.

Consider a case in practice when MRBC is used by a plant operator unfamiliar with both the terminology and characteristics of actuator saturation. Such an operator will be unable to provide the saturation limit of the actuator, which is required by all existing anti-windup designs in commercial solutions. MRBC with gain scaling, however, has no such requirement.

Here, MRBC is compared to a PI controller with anti-windup mechanism. Assuming the plant parameters Kₚ, Tₚ, and T_{L} are all given as in the previous example, where Kₚ=1, Tₚ=10, and T_{L}=0, appropriate set of MRBC parameters can be found in the absence of any information on the actuator limits for 1) fast transient in setpoint change tracking and load change regulation, in reference to the plant time constant Tₚ and delay T_{L}, and 2) the steady state error is less than 5%.

With no information on the actuator saturation limits, the gain-scaled MRBC configuration as shown in FIG. 8 is adopted with

$${K}_{C} ( s ) = {K}_{C} = 2.7 , {T}_{rs} = \frac{P}{I} = 9 ,$$

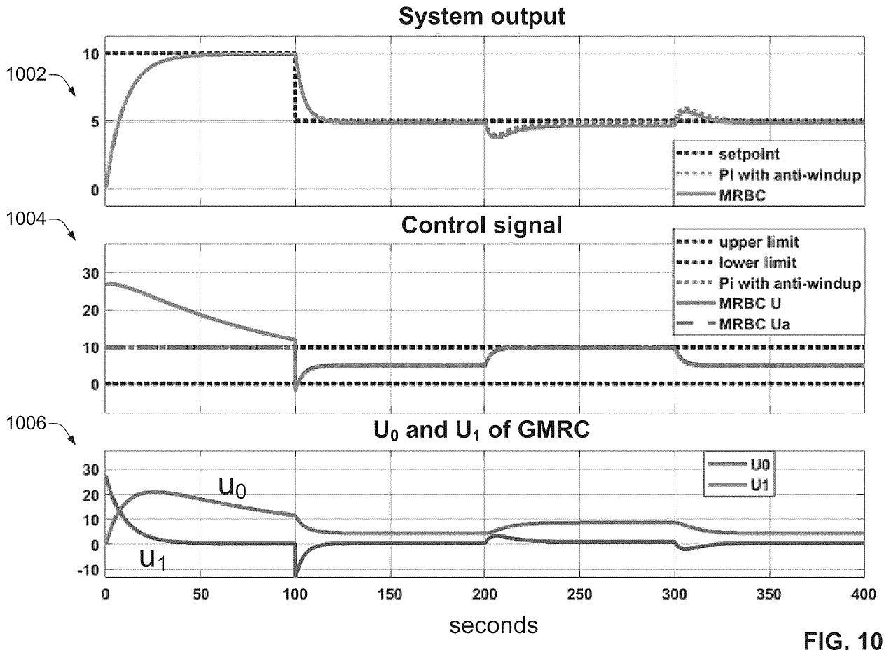

and Kᵣₛ=0.9. The simulation results are shown in FIG. 10. Graphs 1002 and 1004 plot the system output and control signals, respectively, for MRBC with gain-scaling in comparison to PI with anti-windup, and graph 1006 plot the values of u₀ and u₁. As can be seen, MRBC performance is similar to that of the PI with anti-windup. The main difference is that, unlike PI, MRBC does not use any information on the actuator limits. The tradeoff is the 3.6% steady state error, well within the design specification of 5% and can be further reduced if Kᵣₛ is increased. This can be verified by the calculation of the DC gain of the closed-loop transfer function

$${lim}_{s = 0} {G}_{C L} ( s ) = \frac{{K}_{p} {K}_{C}}{1 - {K}_{r s} + {K}_{p} {K}_{{C}_{{K}_{r s} = 0.9}}} = 0.9 \; 643 \qquad ( 16 )$$

Note that Kᵣₛ is the key design parameter, allowing users to balance the needs for controller stability and the tolerance for steady state error.

The design principles of MRBC have been illustrated thus far using the FOPTD plants with examples that have the dead time set to zero. The generic forms of both the Mason Reset and the error correction are now discussed for the purpose of controlling FOPTD plants with a relatively large time delay and unknown actuator saturation limits.

Mason used the first order lowpass filter, of the form of equation (3), in the positive feedback loop shown in FIG. 4, out of the necessity of mechanical simplicity, to which the digital design is not limited. A generic form of Mason reset can take the form of

$${G}_{M R} ( s ) = \frac{{K}_{r s}}{{( {T}_{r s} s + 1 )}^{p}} \qquad ( 17 )$$

with p as a positive integer and 0<Kᵣₛ≤1. The corresponding generic MRBC controller is now

$${G}_{MRBC} ( s ) = {K}_{c} ( s ) \frac{{( s {T}_{r s} + 1 )}^{p}}{{( s {T}_{r s} + 1 )}^{p} - {K}_{r s}} \qquad ( 18 )$$

Note that, compared to equation (14), equation (18) provides an additional degree of freedom in low frequency loop-shaping, while K_{C}(s) is designed to obtain desired dynamic response and stability margins around the crossover frequency. In particular, the primary obstacle and limiting factor in such design is the latency in the loop, including those in the sensors and signal conditioning, the actuator assembly, the controller itself, and the plant. To this end, the error correction compensator below is adopted in the form of a lead compensator to provide enough phase lead at the right frequency

$${K}_{C} ( s ) = {K}_{C} \frac{{( {T}_{c} s + 1 )}^{n}}{{( {αT}_{C} s + 1 )}^{m}} \qquad ( 19 )$$

where K_{C} is the DC gain, T_{C} is a time constant, 0<α<1, and n and m are integers with n≤m. These parameters, i.e., {K_{C}, T_{C}, α, n, m}, are selected via the loop-shaping method to meet the design specifications, as shown in the case study below. This configuration ensures that sufficient phase lead in error correction is provided to compensate for the latency in the control loop, thus enhancing gain and phase stability margins. More generally, K_{C}(s) can be expressed with multiple corner frequencies

$${K}_{C} ( s ) = {K}_{c} \frac{{Π}_{i = 1}^{n} ( {T}_{c i} s + 1 )}{{Π}_{j = 1}^{m} ( {α}_{j} {T}_{c j} s + 1 )} \qquad ( 20 )$$

for ease of loop shaping design.

A case study is now discussed to illustrate the design procedure on a typical FOPTD plant commonly seen in process control. Both time response and frequency response characteristics are used to evaluate the practicality of MRBC.

This case study focuses on two scenarios where the FOPTD plant has a dead time of T_{L}≈Tₚ/5 and T_{L}≈Tₚ, respectively, described as

$${G}_{p 1} ( s ) = \frac{1}{10 s + 1} {e}^{- 2 s} \qquad ( 21 )$$

$${G}_{p 2} ( s ) = \frac{1}{10 s + 1} {e}^{- 10 s} \qquad ( 22 )$$

or T_{L}=0.2Tₚ=2 and T_{L}=Tₚ=10, respectively. The actuator operating range is again [0, 9.9] and the controller is designed to meet the following specifications:
S1: The tracking error is less than 2% in steady state.
S2: Gain margin is at least 10 dB and phase margin is 80°.
S3: Fast transient response in setpoint change tracking and load change regulation.

With regard to S3, it is desired to have a smallest possible closed-loop time constant of T_{cl}, but it would be difficult to prescribe a priori while S1 and S2 are being met. For a relatively large time delay system, the phase angle drops drastically in high frequencies, the phase margin has to be set accordingly, hence the 80° requirement in S2. The uncertain dynamics of actuator and plant delays also means that there needs to be a significant gain margin to ensure stability.

For the plants in equations (21) and (22), m=n=p=1 is selected for the MRBC controller of equations (17)-(19). That is

$${K}_{C} ( s ) = {K}_{c} \frac{{T}_{C} s + 1}{{αT}_{c} s + 1} \qquad ( 23 )$$

$${G}_{GSMR} ( s ) = \frac{{K}_{r s}}{{T}_{r s} s + 1} \qquad ( 24 )$$

The corresponding controller transfer function is

$${G}_{MRBC} ( s ) = {K}_{C} ( s ) {G}_{M R E} ( s ) = {K}_{c} \frac{{T}_{C} s + 1}{{αT}_{c} s + 1} \frac{s {T}_{r s} + 1}{s {T}_{r s} + 1 - {K}_{r s}} with \qquad ( 25 )$$

$${G}_{M R E} ( s ) = \frac{s {T}_{r s} + 1}{s {T}_{r s} + 1 - {K}_{r s}} \qquad ( 26 )$$

Alternatively, for extremely large time delay, G_{GSMR}(s) in equation (24) can be augmented with

$${e}^{- {T}_{L}^{′} s} ,$$

where

$$- {T}_{L}^{′} = k {T}_{L} ,$$

i.e.

$${G}_{GSMR} ( s ) = \frac{{K}_{r s}}{{T}_{r s} s + 1} {e}^{- {T}_{L}^{′} s} \qquad ( 27 )$$

The controller parameters can be selected via different means during field operations, for which a simple procedure is used here based on frequency response method, i.e., loop shaping:
i. Determine plant parameters T_{L}, Tₚ, and Kₚ based on the step time response and set Tᵣₛ=Tₚ+T_{L};
ii. Set Kᵣₛ=0.99 to meet S1;
iii. Determine the phase crossover frequency ω_{pc} of the transfer function G_{MRE}(s)Gₚ(s), where its phase is −180°;
iv. Set T_{c}=ω_{pc}⁻¹ and α=0.1 and adjust K_{c} to meet S2 and S3.

In particular, with Gₚ₁ in equation (21) and T_{L}=2, Tₚ=10, and Kₚ=1, the MR parameters are set as Tᵣₛ=Tₚ+T_{L}=12, Kᵣₛ=0.99. The corresponding phase crossover frequency for G_{MRE}(s)Gₚ(s) is found to be ω_{pc}=0.796 radians per second (r/s). By setting T_{c}=ω_{pc}⁻¹=1/0.796=1.25, α=0.1, the loop gain phase crossover frequency increases to

$${ω}_{pc}^{′} = 1.21 r / s .$$

By setting K_{C}=2.1352, a gain margin of 10 dB and a phase margin of 83° are obtained with the crossover frequency of ω_{c}=0.215 r/s, which cannot be increased further subject to S3.

With Gₚ₂ in equation (22) and T_{L}=10, Tₚ=10, and Kₚ=1, the MR parameters are set as Tᵣₛ=T_{P}+T_{L}=20, Kᵣₛ=0.99. The phase crossover frequency for G_{MRE}(s)Gₚ(s) is found to be ω_{pc}=0.181 r/s. By setting T_{c}=ω_{pc}⁻¹=1/0.181=5.5249 and α=0.1, the loop gain phase crossover frequency increases to

$${ω}_{pc}^{′} = 0.257 r / s .$$

By setting K_{c}=0.4972, a gain margin of 10 dB and a phase margin of 96.5° are obtained with the crossover frequency of ω_{c}=0.0277 r/s. Note that a higher phase margin will ensure smooth transient response because of the large time delay.

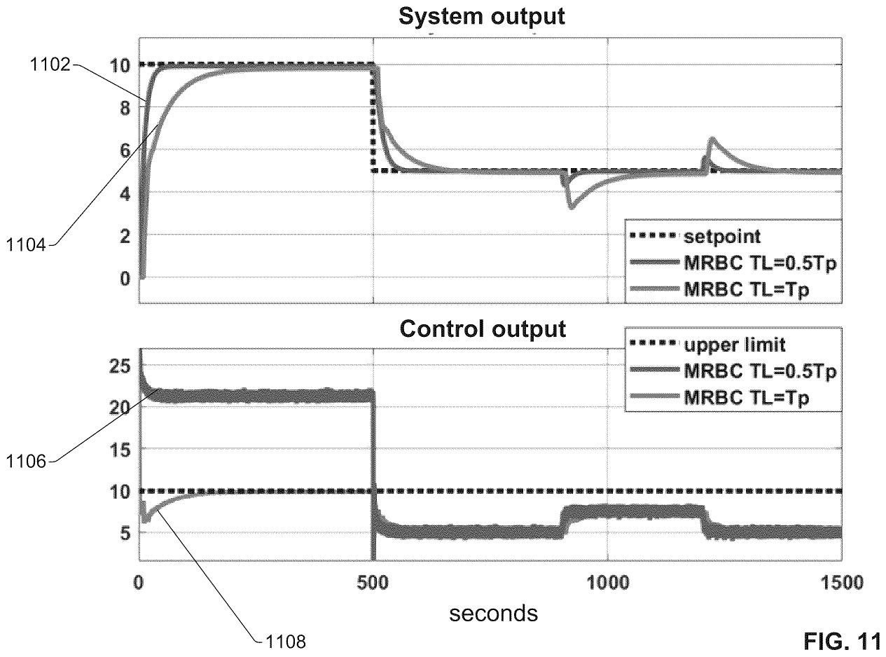

The parameter setting above is validated successfully in simulation, as shown in FIG. 11, which illustrates the closed-loop time response with MRBC. Lines 1102 and 1106 plot the system output and control output, respectively for MRBC with T_{L}=0.5T_{P}, and lines 1104 and 1108 plot the system output and control output, respectively for MRBC with T_{L}−Tₚ. Here, simulation time is increased and step load change reduced to accommodate long time delays. The setpoint starts at 10 and changes to 5 at t=500 seconds; the step load change of −2.5 is introduced at t=900 seconds, another one of +2.5 at t=1200 seconds. The measurement noise (white noise) in output measurement and the actuator saturation limits remain the same as in the previous examples.

For both cases, the DC gain for the plant is 1 and for the closed loop system it is

$$\frac{{K}_{p} {K}_{c}}{1 - {K}_{rs} + {K}_{p} {K}_{c}}$$

which is 0.9953 and 0.9803, respectively; with Kᵣₛ=0.99, the DC gain for the controller is 100K_{c}, which is 212.64 and 49.72, respectively. With setpoint at 10 and Gₚ(s)=Gₚ₁(s), the input to the plant, uₐ in FIG. 8, quickly saturates at 9.9, leading to a steady state error of eₛₛ=0.1 and a controller output u settles at (100K_{c})eₛₛ=21.26; for Gₚ(s)=Gₚ₂(s), the closed loop DC gain, and therefore the step response in steady state, is 0.9803, with no actuator saturation and the controller output in steady state at (10−9.803)(100K_{c})=9.795, as shown in FIG. 11. Once again, there is no integrator windup problem, which is commonly associated with actuator saturation.

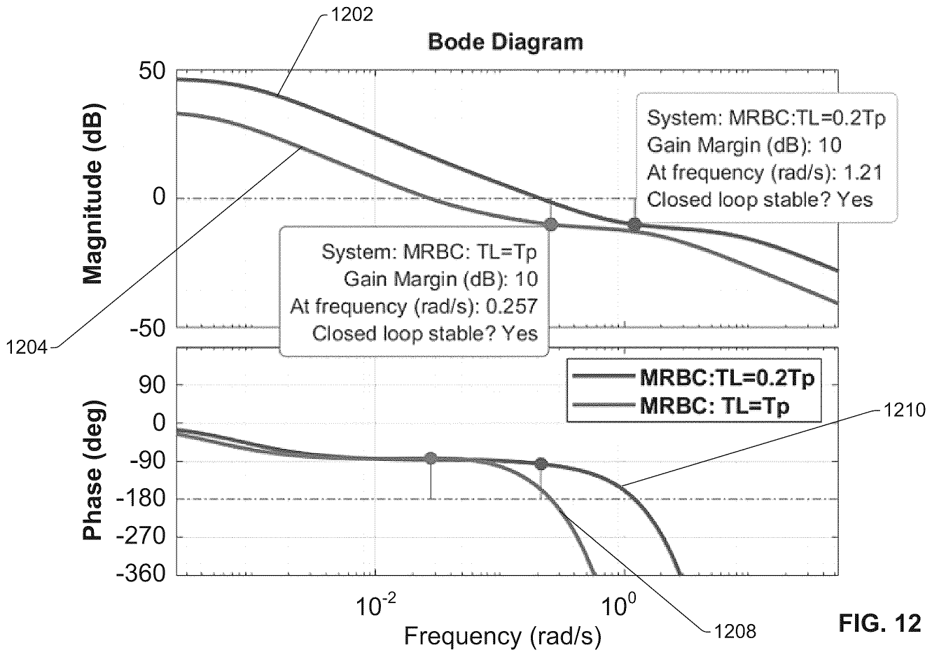

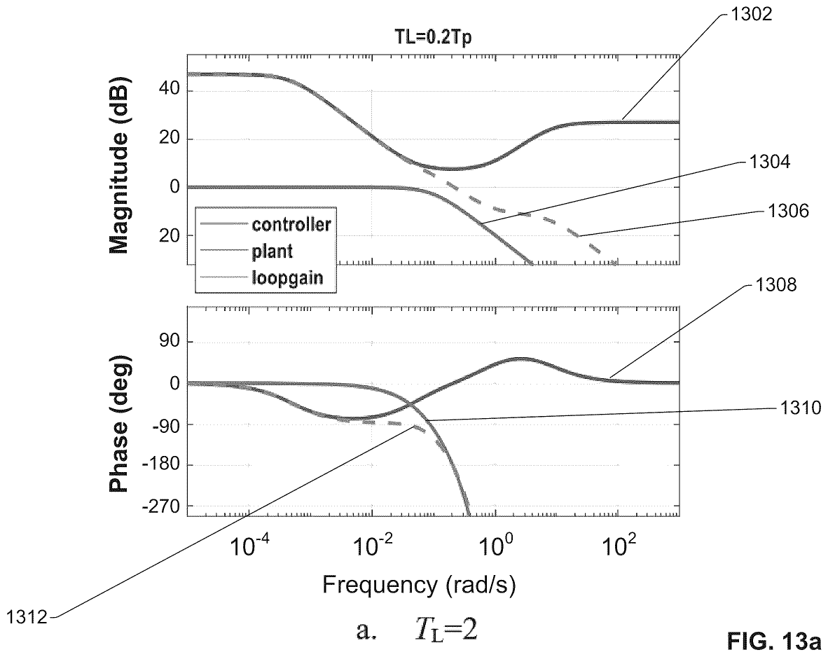

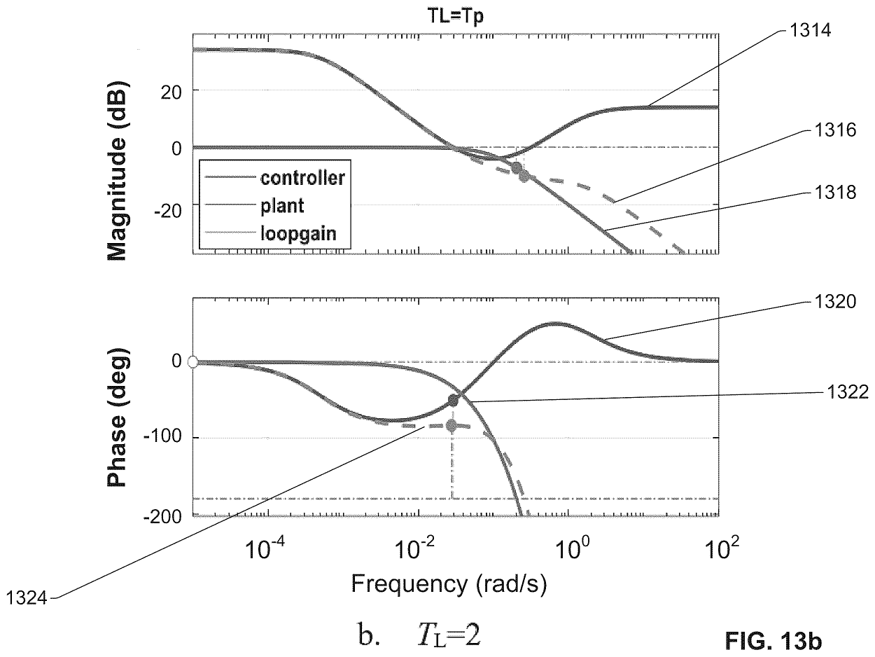

The loop gain frequency responses for both cases are shown in FIG. 12, which is a Bode diagram that plots the magnitudes and phases of the designed loop-gain frequency responses for MRBC with T_{L}=0.2T_{P} (lines 1202 and 1210) and T_{L}=T_{P} (lines 1204 and 1208). It can be seen that, at low frequencies, the plant has a 0 dB gain and the loop gain follows that of G_{MRE}(s) in equation (26), which can be seen more clearly in FIG. 12. Kᵣₛ=0.99 leads to a finite DC gain of 100K_{c} for the controller, for which the first two corner frequencies are provided by G_{MRE}(s), followed by the next two corner frequencies from K_{c} in equation (23). These four corner frequencies, together with the plant pole, is what gives the desired loop frequency response as shown in FIG. 13a, which is a Bode diagram that plots the magnitudes and phases of the individual controller (lines 1302 and 1308), loop gain (lines 1306 and 1312), and plant (lines 1304 and 1310) frequency response with T_{L}=0.2Tₚ, and FIG. 13b, which is a Bode diagram that plots the magnitudes and phases of the individual controller (lines 1314 and 1320), loop gain (lines 1316 and 1324), and plant (lines 1318 and 1322) frequency response with T_{L}=Tₚ. The four corner frequencies and the plant pole also provide the phase lead to meet S2. The gain parameter K_{C} is adjusted to minimize ω_{c}. Note that the rapid phase drop due to the time delay limits how high ω_{c} can go.

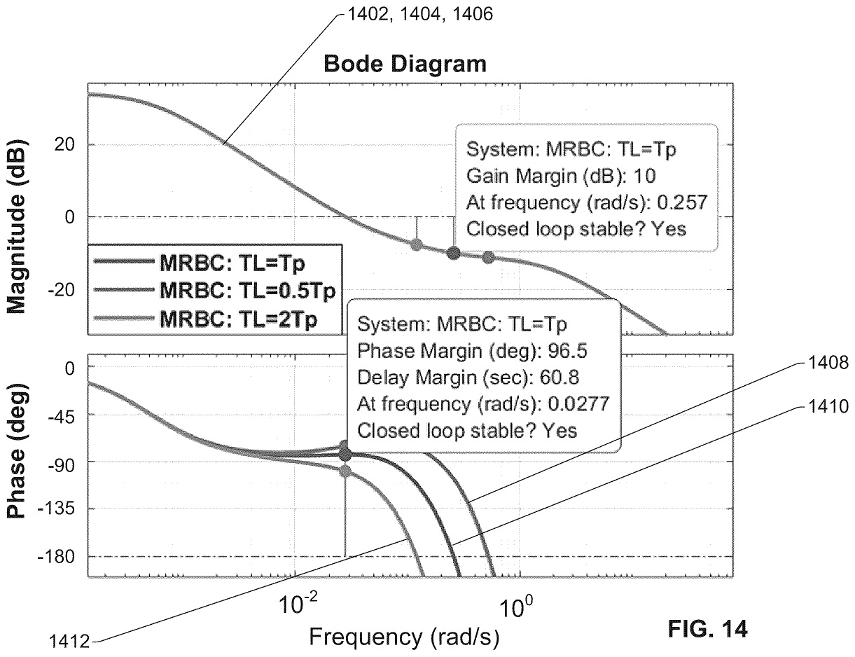

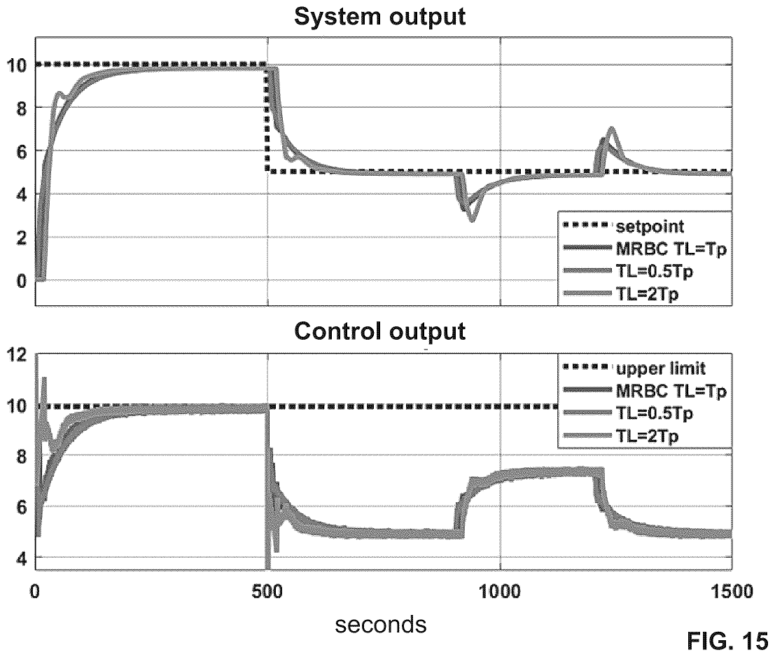

To show the robustness of the MRBC designed for Gₚ₂, i.e., T_{L}=Tₚ, we vary the actual T_{L} from 0.5Tₚ to 2Tₚ and examine both the frequency and time response, as shown in FIGS. 14 and 15. FIG. 14 is a Bode diagram that plots the magnitudes and phases of the designed loop-gain frequency responses for MRBC with T_{L}=Tₚ (lines 1402 and 1410), T_{L}=0.5Tₚ (lines 1404 and 1408) and T_{L}=2Tₚ (lines 1406 and 1412). FIG. 15 illustrates graphs of the closed-loop time response with MRBC. The phase plots shown in FIG. 14 show that the magnitude and phase margines vary between 11.2 to 7.67 dB and 104° and 80.6°, respectively. In addition, all three closed-loop time responses in FIG. 15 are well behaved and acceptable, despite the large swings in time delay. The inherent robustness of MRBC is evident.

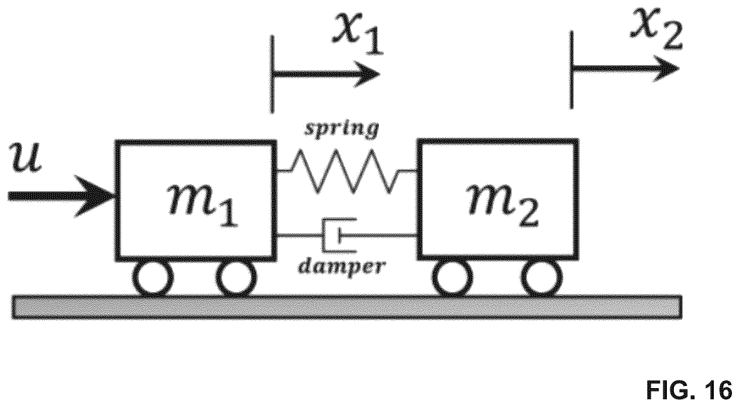

The previous examples and the case study all use variations of the FOPTD model of equation (6), which is most common in the process control industry. But MRBC as a general solution is not limited to such applications. To illustrate its applicability to other kinds of control problems, consider the motion control system with resonant frequency close to or below the closed-loop bandwidth. One such case is that of two masses linked by a soft spring, as shown in FIG. 16, with the transfer function of

$${G}_{p} ( s ) = \frac{{X}_{2}}{u} = \frac{{k}_{s}}{{s}^{4} ( {m}_{1} {m}_{2} ) + {s}^{3} ( {c}_{1} ) + {s}^{2} ( {c}_{2} ) + s ( {c}_{3} )} \qquad ( 28 )$$

where u is the motor input, m₁ and m₂ are the two masses, and X₂ is the displacement of the second mass m₂, which is not directly driven by the motor. Here, c₁, c₂, and c₃ are given by

$${c}_{1} = {m}_{1} {v}_{2} + {m}_{2} {v}_{1} \qquad ( 29 )$$

$${c}_{2} = {k}_{s} ( {m}_{1} + {m}_{2} ) + {v}_{1} {v}_{2} \qquad ( 30 )$$

$${c}_{3} = {k}_{s} ( {v}_{1} + {v}_{2} ) \qquad ( 31 )$$

where the spring constant kₛ=1 newton per meter (N/m), the mass m₁=m₂=1 kilogram (kg), and the friction coefficients on m₁ and m₂ are v₁=v₂=0.01, which means that Gₚ(s) has a resonant frequency at ωᵣ=1.41 r/s. The controller is to be designed to meet the following specifications:
S1: Achieve accurate positioning control with tolerance of 1% overshoot and less than 1% steady state error against the load disturbance.
S2: Gain margin is approximately 10 dB and phase margin is approximately 50°
S3: Fast and damped transient response in reference trajectory tracking and disturbance rejection.

To meet the above specifications of requirements, in the forms of equations (15) and (19), the MRBC controller for this 4^{th} order plant can be designed with kᵣₛ=0.995, p=5, and

$${T}_{rs} = \frac{1}{30 {ω}_{r}} = 0.0236 ,$$

so that

$${G}_{MR} ( s ) = \frac{0.995}{{( 0.0236 s + 1 )}^{5}} \qquad ( 32 )$$

and let n=4 and m=5, T_{c}=1, α=0.02, and K_{c}=1.102, so that

$${K}_{c} ( s ) = \frac{{( s + 1 )}^{4}}{{( 0.02 s + 1 )}^{5}} \qquad ( 33 )$$

Therefore, the equivalent loop-gain transfer function of the control system is

$${L}_{MRBC} ( s ) = 1.102 \frac{{( s + 1 )}^{4}}{{( 0.02 s + 1 )}^{5}} \frac{{( 0.0236 s + 1 )}^{5}}{{( 0.0236 s + 1 )}^{5} - 0.995} {G}_{p} ( s ) \qquad ( 34 )$$

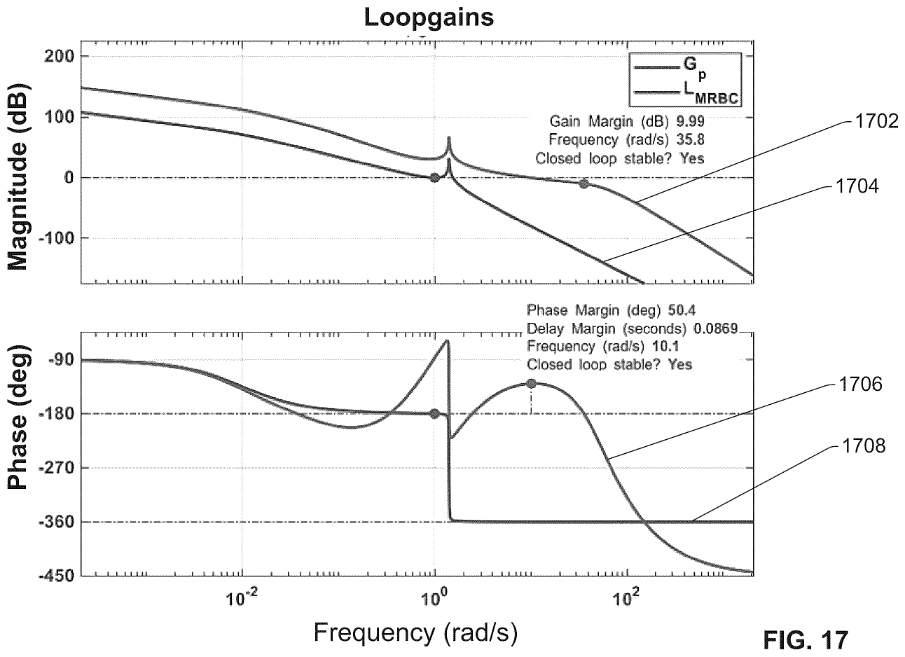

FIG. 17 is a Bode diagram that plots the frequency responses of the plant Gₚ(s) (lines 1704 and 1708) and MRBC controlled loop-gain transfer function L_{MRBC}(s) (lines 1702 and 1706), which has a crossover frequency of ω_{c}=10.1 r/s, a phase margin of 50.4°, and a gain margin of 9.99 dB. Note that L_{MRBC}(s) has the same slope at low-frequency gains as that of Gₚ(s), indicating that the controller has no integrators.

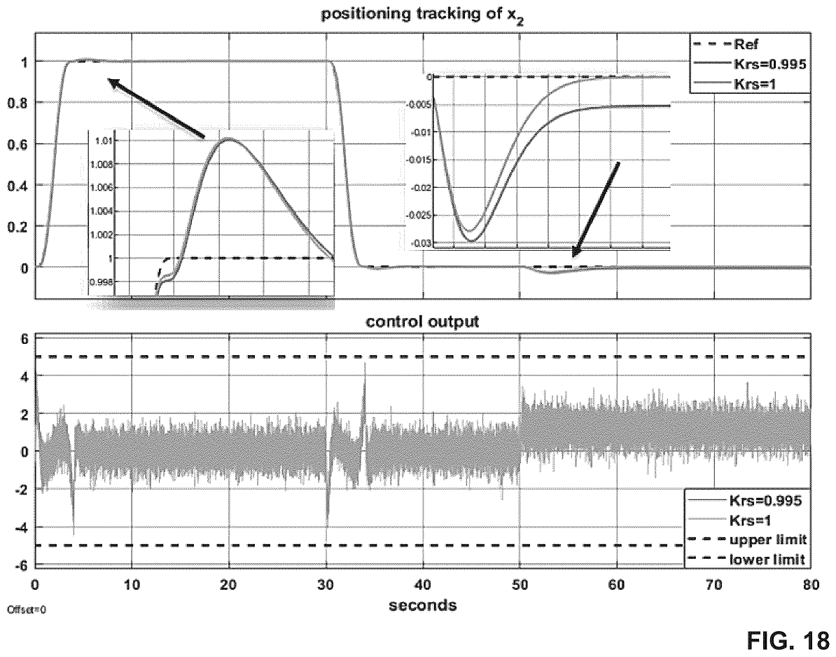

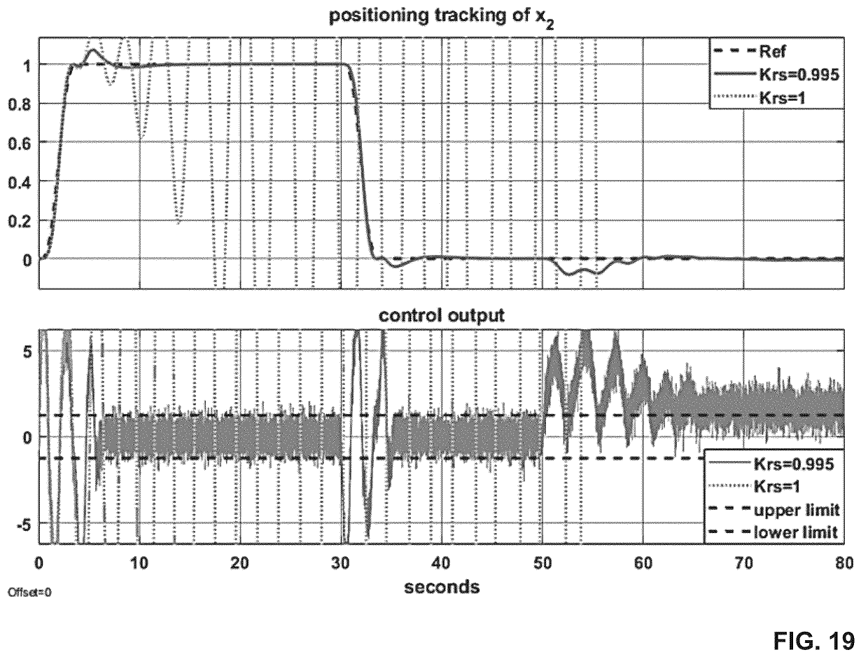

FIG. 18 illustrates tracking and disturbance rejection performance with actuator saturation of ±5 for Kᵣₛ=0.995 and Kᵣₛ=1. FIG. 19 illustrates the frequency responses of Gₚ(s) and MRBC controlled loop-gain system L_{MRBC}(s). As shown in these figures, the MRBC design is validated in the time domain in terms of reference trajectory tracking, load disturbance rejection, and the noise sensitivity in control signal. The reference trajectory is a typical industrial motion profile with S-curve, and the rising time is set to 4 seconds with an amplitude of 1. A step input with an amplitude of 116% of the setpoint is introduced at 50 seconds as the external load disturbance. A white noise is introduced into the system output measurement of x₂ to mimic the sensor noise.

As shown above, with Kᵣₛ=1, the zero steady state error can be mathematically achieved at the cost of the controller not being BIBO stable. This compromise is again illustrated here with Kᵣₛ=0.995 and Kᵣₛ=1, respectively, to be tested in simulation under the actuator saturation limits of ±5 and ±1.25.

With the saturation limits of ±5, the simulation results shown in FIG. 18 show that both controllers work equally well in tracking, disturbance rejection, and noise sensitivity. The only difference is in the steady state error: zero for Kᵣₛ=1 and 0.5% for Kᵣₛ=0.995. With the saturation limits of ±1.25, however, the control system becomes unstable with Kᵣₛ=1 but remains stable with Kᵣₛ=0.995.

From the frequency response characteristics shown in FIG. 17 and the time domain performance shown in FIGS. 18 and 19, it is shown that the proposed MRBC control method can be extended to other domains of industrial control, such as motion control systems. Furthermore, the ability of MRBC to deal with complications in the plant, such as unknown resonant modes within the control bandwidth and actuator saturation, is demonstrated. Typically, for this type of application, the higher order derivatives of the motion profile are incorporated as the feed-forward control for better tracking performance. This case study shows that such requirements can be avoided in meeting all the design requirements.

The MRBC control method described herein, which incorporates the principles of reset and synchronization, shows a simple but eluding fact: the function of integral control, for the purpose of attaining zero steady state error in the presence of constant load change, can be realized without an explicit numerical integrator. This means that if explicit integral control common in industrial control apparatuses is replaced by the Mason Reset, there would be no integral windup problems, and hence no need for any anti-windup mechanism. In addition, the understanding of Mason Reset makes bare the false equivalency commonly seen in control literature between Mason Reset and the integral control term in PID control. This leads to a new way of thinking about and implementing feedback control. Specifically, the degree of integration can be calibrated by gain-scaling the positive feedback in Mason Reset, thus offering a new kind of trade-off between the pros and cons of integral control.

The potential wide-ranging impact on industrial control is shown in the case study where the Mason Reset based control is applied to FOPTD plants, ubiquitous in practice where uncertainties abound in the process time constant, the dead time, and dynamics and saturation limits of actuators. The MRBC solution described herein exhibits characteristics that differentiate MRBC from PID control. For example, unlike the parallel three-term sum PID form, MRBC in the cascade structure is seamlessly meshed with the well-established frequency response design and analysis method—i.e., loop-shaping—which connects its parameters to either the overall controller gain or its corner frequencies. In other words, the controller parameters can be logically determined based on the loop gain requirements and constraints, thus eliminating the guesswork in controller tuning.

Also, the MRBC controller avoids the so-called integrator windup problem entirely in two different ways: a) by inserting a saturation block in the forward path of the MR loop (e.g., saturation block 404 shown in FIG. 4); and b) by gain-scaling the positive feedback in MR. The MRBC is also made robust against variations in process time constant, dead time, actuator saturation, and process gain. Moreover, the MRBC can be applied in a wide range of industrial applications such as process and motion controls.

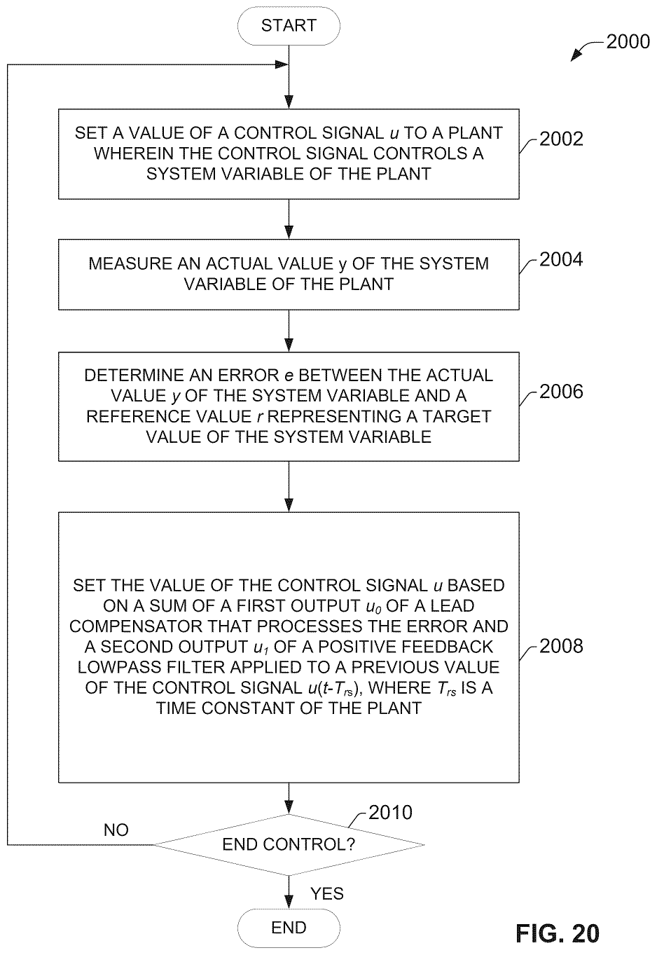

FIG. 20 illustrates a methodology in accordance with certain disclosed aspects. While, for purposes of simplicity of explanation, the methodology is shown and described as a series of acts, it is to be understood and appreciated that the disclosed aspects are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain disclosed aspects. Additionally, it is to be further appreciated that the methodologies disclosed hereinafter and throughout this disclosure are capable of being stored on an article of manufacture to facilitate transporting and transferring such methodologies to computers.

FIG. 20 illustrates an example methodology 2000 for controlling a plant using Mason reset based control (MRBC). Initially, at 2002, a value of a control signal u to a plant is set (e.g., by a controller that supports MRBC control). The control signal u controls a system variable of the plant, such as a speed, a position, a flow, a pressure, a temperature, or another system variable.

At 2004, an actual value y of the system variable is measured. At 2006, an error e between the actual value y of the system variable and a reference value r representing a target value of the system variable. The target value can be generated, for example, by an industrial control program that monitors and controls the plant.

At 2004, the value of the control signal u is adjusted or regulated based on a sum of a first output u₀ of a lead compensator that processes the error e and a second output u₁ of a positive feedback lowpass filter applied to a previous value of the control signal u(t−Tᵣₛ), where Tᵣₛ is a time constant of the plant. Upper and lower limits can be enforced on the result u_{c} of this sum using a saturation block in the forward path of the Mason reset loop to yield the value of the control signal u. This control approach essentially replaces the explicit integrator of PID control with a generalized reset loop, which can achieve stable performance that mitigates or eliminates integral windup.

At 2010, a determination is made as to whether control of the plant is ended. If the control is to continue (NO at step 2010), the methodology returns to step 2002, and steps 2002-2008 are performed continuously until a command is received to end the control. When a command to end the control is received (YES at step 2010), the methodology ends.

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments of the parameter identification system described herein can be implemented in any computer system or environment having any number of memory or storage units (e.g., memory 222 of FIG. 2), and any number of applications and processes occurring across any number of storage units. This includes, but is not limited to, an environment with server computers and client computers deployed in a network environment or a distributed computing environment, having remote or local storage. For example, with reference to FIG. 2, the program execution component 204, MRBC control component 206, I/O component 208, and networking component 210 can be stored on a single memory 222 associated with a single device, or can be distributed among multiple memories associated with respective multiple devices. Similarly, components 204, 206, 208, and 210 can be executed by a single processor 220, or by multiple distributed processors associated with multiple devices.

Distributed computing provides sharing of computer resources and services by communicative exchange among computing devices and systems. These resources and services include the exchange of information, cache storage and disk storage for objects. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

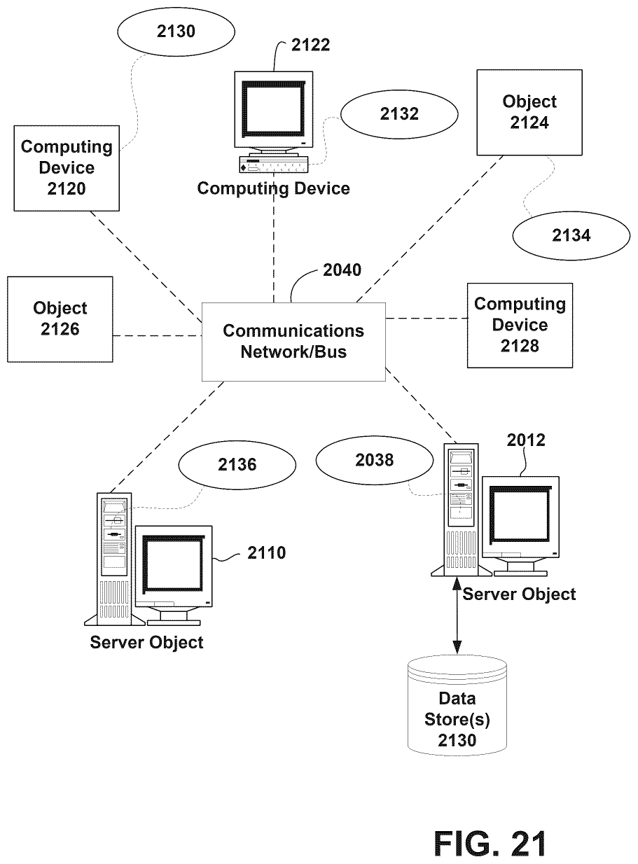

FIG. 21 provides a schematic diagram of an exemplary networked or distributed computing environment. The distributed computing environment includes computing objects 2110, 2112, etc. and computing objects or devices 2120, 2122, 2124, 2126, 2128, etc., which may include programs, methods, data stores, programmable logic, etc., as represented by applications 2130, 2132, 2134, 2136, 2138. It can be appreciated that computing objects 2110, 2112, etc. and computing objects or devices 2120, 2122, 2124, 2126, 2128, etc. may comprise different devices, such as personal digital assistants (PDAs), audio/video devices, mobile phones, MP3 players, personal computers, laptops, tablets, etc., where embodiments of the inertia estimator described herein may reside on or interact with such devices.

Each computing object 2110, 2112, etc. and computing objects or devices 2120, 2122, 2124, 2126, 2128, etc. can communicate with one or more other computing objects 2110, 2112, etc. and computing objects or devices 2120, 2122, 2124, 2126, 2128, etc. by way of the communications network 2140, either directly or indirectly. Even though illustrated as a single element in FIG. 20, communications network 2140 may comprise other computing objects and computing devices that provide services to the system of FIG. 20, and/or may represent multiple interconnected networks, which are not shown. Each computing object 2110, 2112, etc. or computing objects or devices 2120, 2122, 2124, 2126, 2128, etc. can also contain an application, such as applications 2130, 2132, 2134, 2136, 2138, that might make use of an API, or other object, software, firmware and/or hardware, suitable for communication with or implementation of various embodiments of this disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any suitable network infrastructure can be used for exemplary communications made incident to the systems as described in various embodiments herein.

Thus, a host of network topologies and network infrastructures, such as client/server, peer-to-peer, or hybrid architectures, can be utilized. The “client” is a member of a class or group that uses the services of another class or group. A client can be a computer process, e.g., roughly a set of instructions or tasks, that requests a service provided by another program or process. A client process may utilize the requested service without having to “know” all working details about the other program or the service itself.

In a client/server architecture, particularly a networked system, a client can be a computer that accesses shared network resources provided by another computer, e.g., a server. In the illustration of FIG. 21, as a non-limiting example, computing objects or devices 2120, 2122, 2124, 2126, 2128, etc. can be thought of as clients and computing objects 2110, 2112, etc. can be thought of as servers where computing objects 2110, 2112, etc. provide data services, such as receiving data from client computing objects or devices 2120, 2122, 2124, 2126, 2128, etc., storing of data, processing of data, transmitting data to client computing objects or devices 2120, 2122, 2124, 2126, 2128, etc., although any computer can be considered a client, a server, or both, depending on the circumstances. Any of these computing devices may be processing data, or requesting transaction services or tasks that may implicate the techniques for systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 2140 is the Internet, for example, the computing objects 2110, 2112, etc. can be Web servers, file servers, media servers, etc. with which the client computing objects or devices 2120, 2122, 2124, 2126, 2128, etc. communicate via any of a number of known protocols, such as the hypertext transfer protocol (HTTP). Computing objects 2110, 2112, etc. may also serve as client computing objects or devices 2120, 2122, 2124, 2126, 2128, etc., as may be characteristic of a distributed computing environment.

### Exemplary Computing Device

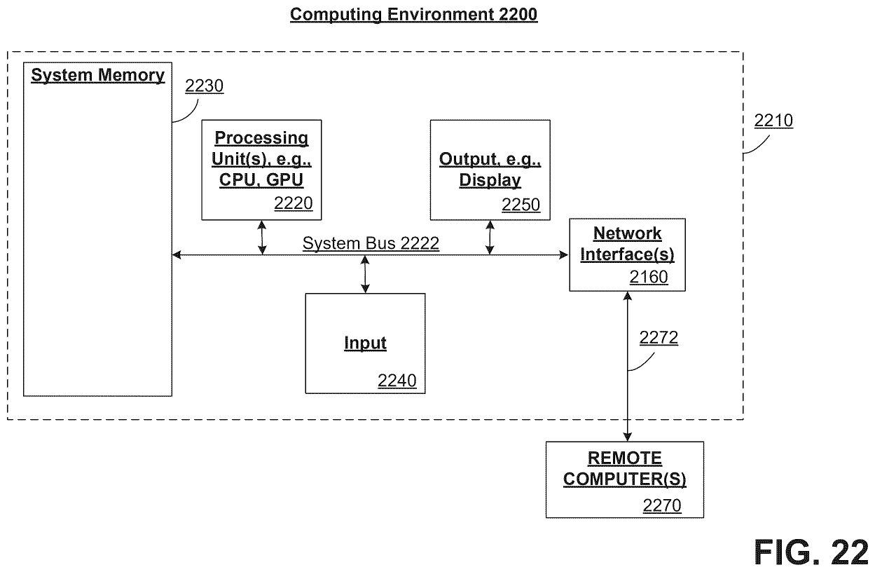

As mentioned, advantageously, the techniques described herein can be applied to any suitable device. It is to be understood, therefore, that handheld, portable and other computing devices and computing objects of all kinds are contemplated for use in connection with the various embodiments. Accordingly, the below computer described below in FIG. 22 is but one example of a computing device. Additionally, a suitable server can include one or more aspects of the below computer, such as a media server or other media management server components.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 22 thus illustrates an example of a suitable computing system environment 2200 in which one or aspects of the embodiments described herein can be implemented, although as made clear above, the computing system environment 2200 is only one example of a suitable computing environment and is not intended to suggest any limitation as to scope of use or functionality. Neither is the computing system environment 2200 be interpreted as having any dependency or requirement relating to any one or combination of components illustrated in the exemplary computing system environment 2200.

With reference to FIG. 22, an exemplary computing device for implementing one or more embodiments in the form of a computer 2210 is depicted. Components of computer 2210 may include, but are not limited to, a processing unit 2220, a system memory 2230, and a system bus 2222 that couples various system components including the system memory to the processing unit 2220. Processing unit 2220 may, for example, perform functions associated with processor(s) 220 of controller 202, while system memory 2230 may perform functions associated with memory 222.

Computer 2210 typically includes a variety of computer readable media and can be any available media that can be accessed by computer 2210. The system memory 2230 may include computer storage media in the form of volatile and/or nonvolatile memory such as read only memory (ROM) and/or random access memory (RAM). By way of example, and not limitation, system memory 2230 may also include an operating system, application programs, other program modules, and program data.

A user can enter commands and information into the computer 2210 through input devices 2240, non-limiting examples of which can include a keyboard, keypad, a pointing device, a mouse, stylus, touchpad, touchscreen, trackball, motion detector, camera, microphone, joystick, game pad, scanner, or any other device that allows the user to interact with computer 2210. A monitor or other type of display device is also connected to the system bus 2222 via an interface, such as output interface 2250. In addition to a monitor, computers can also include other peripheral output devices such as speakers and a printer, which may be connected through output interface 2250. In one or more embodiments, input devices 2140 can provide user input to controller 202, while output interface 2250 can receive information relating to operations of the controller 202.

The computer 2210 may operate in a networked or distributed environment using logical connections to one or more other remote computers, such as remote computer 2270. The remote computer 2270 may be a personal computer, a server, a router, a network PC, a peer device or other common network node, or any other remote media consumption or transmission device, and may include any or all of the elements described above relative to the computer 2210. The logical connections depicted in FIG. 22 include a network 2272, such local area network (LAN) or a wide area network (WAN), but may also include other networks/buses e.g., cellular networks.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques described herein. Thus, embodiments herein are contemplated from the standpoint of an API (or other software object), as well as from a software or hardware object that implements one or more aspects described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the aspects disclosed herein are not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media (e.g., memory 520) and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In order to provide for or aid in any inferences described herein, components described herein can examine the entirety or a subset of the data to which it is granted access and can provide for reasoning about or infer states of the system, environment, etc. from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several events and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

What is claimed is:

1. An industrial controller, comprising:
a memory; and
a processor configured to execute components stored on the memory, the components comprising:
a program execution component configured to execute an industrial control program that sets a reference value of a system variable of a plant; and
a Mason Reset based control (MRBC) control component configured to set a value of a control signal u(t) that controls the system variable based on (1) an error signal e(t) representing a difference between the reference value and a measured value of the system variable, and (2) a previous value of the control signal u(t−Tᵣₛ), where Tᵣₛ is a reset time constant and t is time,
wherein the MRBC control component sets the control signal u(t) as a sum of a first output u₀ of a lead compensator that processes the error signal e(t), and a second output u₁≈u(t−Tᵣₛ) obtained via a positive feedback through a lowpass filter with the time constant of Tᵣₛ.

2. The industrial controller of claim 1, wherein the lowpass filter has a form of
$${G}_{MR} ( s ) = \frac{{K}_{rs}}{{( {T}_{rs} s + 1 )}^{p}}$$
where Kᵣₛ is a gain scaling factor and p is a positive integer.

3. The industrial controller of claim 1, wherein the lead compensator has a form of
$${K}_{C} ( s ) = {K}_{c} \frac{{( {T}_{C} s + 1 )}^{n}}{{( α {T}_{c} s + 1 )}^{m}}$$
where K_{c} is a direct current (DC) gain, T_{C} is a time constant, 0<α<1, and n and m are integers with n≤m.

4. The industrial controller of claim 1, wherein the plant is at least one of a motor-driven industrial automation system; an industrial tool; an industrial robot; a conveyor system; a propulsion system of an electric vehicle; component of a heating, ventilating, and air conditioning (HVAC) system; or a home appliance.

5. The industrial controller of claim 1, wherein the industrial controller comprises at least one of a programmable logic controller, a safety relay, a motor drive, a system-on-chip, or a soft controller.

6. The industrial controller of claim 1, wherein the positive feedback lowpass filter has a form of
$${G}_{MR} ( s ) = \frac{{e}^{- {sT}_{L}^{′}}}{{T}_{rs} s + 1}$$
where Tᵣₛ is the reset time constant and
$${T}_{L}^{′}$$
is a time delay of a response of the system variable to the control signal scaled by a positive constant between 0 and 1.

7. The industrial controller of claim 1, wherein the MRBC control component sets the control signal u(t) without accumulating past error over time.

8. The industrial controller of claim 1, wherein the MRBC control component uses a reset loop in place of an explicit integrator.

9. The industrial controller of claim 1, wherein the MRBC control component implements a saturation block on the sum of the first output and the second output.

10. The industrial controller of claim 1, wherein the lowpass filter has a form of
$${G}_{GSMR} ( s ) = \frac{{K}_{rs}}{{T}_{rs} s + 1}$$
where Kᵣₛ is a gain scaling factor between 0 and 1.

11. The industrial controller of claim 10, wherein a transfer function between the first output of a lead compensator and control signal u(t) has a form of
$${G}_{GSMRE} ( s ) = \frac{{sT}_{rs} + 1}{{sT}_{rs} + 1 - {K}_{rs}} .$$

12. A method, comprising:
setting, by a system comprising a processor, a reference value r(t) of a system variable of a plant; and
setting, by the system, a value of a control signal u(t) that controls the system variable based on an error signal e(t) representing a difference between the reference value r(t) and a measured value y(t) of the system variable,
wherein the setting of the value of the control signal u(t) comprises setting the value of the control signal u as a sum u_{c} of a first output u₀ of a lead compensator that processes the error signal e(t), and a second output u₁ of a positive feedback lowpass filter applied to a previous value of the control signal u(t−Tᵣₛ), where Tᵣₛ is a reset time constant and t is time.

13. The method of claim 12, wherein the positive feedback lowpass filter has a form of
$${G}_{MR} ( s ) = \frac{{K}_{rs}}{{( {T}_{rs} s + 1 )}^{p}}$$
where Kᵣₛ is a gain scaling factor and p is a positive integer.

14. The method of claim 12, wherein the lead compensator has a form of
$${K}_{C} ( s ) = {K}_{c} \frac{{( {T}_{C} s + 1 )}^{n}}{{( α {T}_{c} s + 1 )}^{m}}$$
where K_{c} is a direct current (DC) gain, T_{C} is a time constant, 0<α<1, and n and m are integers with n≤m.

15. The method of claim 12, wherein the plant is at least one of a motor-driven industrial automation system; an industrial tool; an industrial robot; a conveyor system; a propulsion system of an electric vehicle; component of a heating, ventilating, and air conditioning (HVAC) system; or a home appliance.

16. The method of claim 12, wherein the system comprises at least one of a programmable logic controller, a safety relay, a motor drive, a system-on-chip, or a soft controller.

17. The method of claim 12, wherein setting comprises setting the control signal u(t) without accumulating past error over time.

18. The method of claim 12, further comprising limiting, by the system, the control signal u(t) by an upper and lower value of u_{c} via a saturation block between u_{c} and u.

19. A non-transitory computer-readable medium having stored thereon executable components that, in response to execution by a system comprising a processor, cause the system to perform operations, the operations comprising:
setting a reference value r of a system variable of a plant; and
setting a value of a control signal u(t) that controls the system variable based on an error signal e(t) representing a difference between the reference value r and a measured value y(t) of the system variable,
wherein the setting of the value of the control signal u(t) comprises setting the value of the control signal u as a sum u_{c} of a first output u₀ of a lead compensator that processes the error signal e(t), and a second output u₁ of a positive feedback lowpass filter applied to a previous value of the control signal u(t−Tᵣₛ), where Tᵣₛ is a reset time constant and t is time.

20. The non-transitory computer-readable medium of claim 19, wherein the positive feedback lowpass filter has a form of
$${G}_{MR} ( s ) = \frac{{K}_{rs}}{{( {T}_{rs} s + 1 )}^{p}}$$
where Kᵣₛ is a gain scaling factor and p is a positive integer.
